(19) United States
(12) Patent Application Publication
(10) Pub. No.: US 2025/0308272 A1
(43) Pub. Date: Oct. 2, 2025

(54) SUBJECT IDENTIFICATION IN DISTORTED IMAGES

(71) Applicant: THE REGENTS OF THE UNIVERSITY OF CALIFORNIA, Oakland, CA (US)

(72) Inventors: Saisri Padmaja Jonnalagedda, San Jose, CA (US); Bir Bhanu, Riverside, CA (US)

(21) Appl. No.: 19/090,307

(22) Filed: Mar. 25, 2025

Related U.S. Application Data
(60) Provisional application No. 63/570,161, filed on Mar. 26, 2024.

(51) Int. Cl. G06V 30/146; G06T 3/40; G06T 7/11; G06V 10/40

(52) U.S. Cl. CPC G06V 30/1473; G06T 3/40; G06T 7/11; G06V 10/40; G06T 2207/20041

(57) ABSTRACT

Methods and systems for determining an identity of a subject based on a single-frame binary shape-capturing image extracted from distorted image of the subject and using a shape-based biometric image derived from the shape-capturing image. The shape-based biometric image includes a biometric feature of the subject and is generated by transforming the shape-capturing image to a distance transformed image and deriving a multi-scale representation of the distance transformed image. The identity of the subject can be further determined using an outfit regularizing biometric image derived from the distorted image using the shape-based biometric image. The outfit regularizing biometric includes biometric feature of the subject independent of an outfit of the subject and is generated by replacing a region of subject's boy covered by an outfit with corresponding region of the shape-based biometric image.

### INCORPORATION BY REFERENCE TO ANY PRIORITY APPLICATIONS

This application claims the benefit of priority under 35 U.S.C. § 119(e) to U.S. Provisional Application No. 63/570,161, titled MACHINE LEARNING BASED SKELETON GENERATION filed on Mar. 26, 2024, the entire disclosure of which is expressly incorporated herein by reference. Any and all applications for which a foreign or domestic priority claim is identified in the Application Data Sheet as filed with the present application are hereby incorporated by reference under 37 CFR 1.57.

### STATEMENT REGARDING FEDERALLY SPONSORED R&D

This invention was made with U.S. Government support under Contract No. 2022-21102100001, awarded by the Office of the Director of National Intelligences. The Government has certain rights in the invention.

### BACKGROUND

### Field

This disclosure relates to the field of image-based or video-based human recognition using image processing and machine learning. In particular, systems and methods for deriving biometric images from raw images captured under distortive conditions.

### Description of Related Art

Identifying and recognizing an individual based on an image or multiple images (e.g., associated with a video recording) captured by an imaging system under a certain imaging conditions, such as long range, changes in clothing, atmospheric turbulence, that may reduce clarity of the image or visibility of biometric features of the individual's image is a challenging but important task in a wide range of applications including surveillance, virtual reality, authentication, smart systems, and the like. Additionally, recognizing human subjects across cameras mounted on various platforms and under diverse imaging conditions is of significant interest in any of the above-mentioned applications. Identification systems that perform whole-body biometric identification can overcome some of the challenges of appearance-based identification.

### SUMMARY

In some aspects, the techniques described herein relate to a computer-implemented method of determining identity of a subject using a shape-capturing image including the subject, the computer-implemented method including: by an electronic processor, which is configured to execute specific computer-executable instructions stored in a non-transitory memory: receiving the shape-capturing image; generating a distance transformed image using the shape-capturing image; generating a multi-scale representation of the distance transformed image, extracting a first feature embedding from the multi-scale representation using a recognition model, the feature embedding including a numerical representation of a feature in the multi-scale representation; and determining the identity of the subject using at least a reference feature embedding and the first feature embedding.

In some aspects, the techniques described herein relate to a biometric system for determining identity of a subject using a shape-capturing image, the biometric system including: a data interface configured to receive the shape-capturing image; a non-transitory memory configured to store specific computer-executable instructions; and an electronic processor in communication with the non-transitory memory and configured to execute the specific computer-executable instructions to at least: generate a distance transformed image using the shape-capturing image; generate a multi-scale representation of the distance transform image, the multi-scale representation including features corresponding to a skeleton of the subject; extract a feature embedding of the multi-scale representation using a recognition model; and

In some aspects, the techniques described herein relate to a computer-implemented method of determining identity of a subject using a raw image including the subject, the computer-implemented method including: by an electronic processor, which is configured to execute specific computer-executable instructions stored in a non-transitory memory: receiving a shape-based biometric image of the subject including a biometric pattern associated with the subject; generating an enhanced parsed image of the subject using the raw image, the enhanced parsed image including at least one suppressed region corresponding a covered body portion of the subject; replacing the suppressed region with the corresponding region of the shape-based biometric image to generate a composite parsed image; and extracting a first feature embedding from the composite parsed image using a recognition model; and determining the identity of the subject using a first reference feature embedding and at least the first feature embedding.

In some aspects, the techniques described herein relate to a biometric system for determining identity of a subject using a shape-capturing image, the biometric system including: a data interface configured to receive the shape-capturing image; a non-transitory memory configured to store specific computer-executable instructions; and an electronic processor in communication with the non-transitory memory and configured to execute the specific computer-executable instructions to at least: receive a shape-based biometric image of the subject including a biometric pattern associated with the subject; generate an enhanced parsed image of the subject using the raw image, the enhanced parsed image including at least one suppressed region corresponding a covered body portion of the subject; replace the suppressed region with the corresponding region of the shape-based biometric image to generate a composite parsed image; and extract a first feature embedding of the composite parsed image using a recognition model; and determine the identity of the subject using at least a first reference feature embedding and the feature embedding.

In some aspects, the techniques described herein relate to a computer-implemented method of determining identity of a subject using a feature embedding extracted from a raw image including a subject, the method including: by an electronic processor, which is configured to execute specific computer-executable instructions stored in a non-transitory memory: generating, using the raw image, a shape-capturing image including a shape of the subject; generating a distance transformed image using the shape-capturing image; generating multi-scale representation of the distance transformed image, the multi-scale representation including a first shape-based biometric image of the subject; extracting a first feature embedding using at least the multi-scale representation; and determining the identity of the subject using at least a first reference feature embedding and the first feature embedding.

In some aspects, the techniques described herein relate to a computer-implemented method of extracting a feature embedding from an image, the computer-implemented method including: by an electronic processor, which is configured to execute specific computer-executable instructions stored in a non-transitory memory: receiving the image; generating a primary feature embedding using a recognition model; and optimizing the primary feature embedding to generate the feature embedding.

In some aspects, the techniques described herein relate to a computer-implemented method of determining identity of a subject using at least two images including the subject, the computer-implemented method including: by an electronic processor, which is configured to execute specific computer-executable instructions stored in a non-transitory memory: receiving a first image including the subject; receiving a second image including a multi-scale representation of a distance transformed image derived from a raw image including the subject; generating a first matching score by extracting a first feature embedding from the first image and determining a distance between the first feature embedding and a reference feature embedding; generating a second matching score by extracting a second feature embedding from the second image and determining a distance between the second feature embedding and the second reference feature embedding; aggregating the first and second scores to generate an aggregated score; and determining the identity of the subject using the aggregated score.

In some aspects, the techniques described herein relate to a computer-implemented method of determining an identity of a subject using a single-frame silhouette, the computer-implemented method including: by an electronic processor that is configured to execute specific computer-executable instructions stored in a non-transitory memory: receiving a silhouette image including the subject; generating a distance transformed image using the silhouette image; generating a representation image using the distance transform image, the representation image including features corresponding to a skeleton of the subject; extracting a vector embedding of the representation image using a recognition model, the vector embedding includes a numerical representation of a feature of the representation image; and determining the identity of the subject using a reference vector embedding and the vector embedding. In some examples, generating the representation image comprises generating a Difference of Gaussians (DoG) pyramid.

In some aspects, the techniques described herein relate to a computer-implemented method, wherein generating the representation image includes computing a difference of Gaussian (DoG) or a difference of Gaussian (DoG) pyramid.

In some aspects, the techniques described herein relate to a computer-implemented method, wherein generating the representation image includes: using the DoG pyramid to generate a plurality of representation images based on a plurality of octaves and scales; and selecting the representation image.

In some aspects, the techniques described herein relate to a computer-implemented method, wherein generating the representation image includes selecting at least two representation images from the plurality of representation images.

In some aspects, the techniques described herein relate to a computer-implemented method, wherein extracting the vector embedding includes training the recognition model by performing multi-scale feature concatenation to hierarchically fuse high resolution and low-resolution features.

In some aspects, the techniques described herein relate to a computer-implemented method, wherein recognition model includes a multilayer High-Resolution network (HR-NET).

In some aspects, the techniques described herein relate to a computer-implemented method, wherein extracting the vector embedding includes generating a primary vector embedding using the recognition model and optimizing the primary vector embedding to generate the vector embedding.

In some aspects, the techniques described herein relate to a computer-implemented method, wherein optimizing the primary vector embedding includes performing multi-objective optimization using a loss function.

In some aspects, the techniques described herein relate to a computer-implemented method, wherein determining the identity of the subject includes: generating the reference vector embedding; and determining a cosine distance of the reference vector embedding with respect to the vector embedding.

In some aspects, the techniques described herein relate to a computer-implemented method, wherein generating the reference vector embedding includes aggregating a plurality of reference vector embeddings using averaging to obtain the reference vector embedding.

In some aspects, the techniques described herein relate to a computer-implemented method, wherein generating the distance transformed image includes: generating an inverse of the silhouette image; and determining the distance transformed image using the inverse of the silhouette image.

In some aspects, the techniques described herein relate to a computer-implemented method, wherein the feature includes the skeleton of the subject.

In some aspects, the techniques described herein relate to a computer-implemented method, wherein the reference vector embedding includes a numerical representation of a reference feature extracted from a reference image.

In some aspects, the techniques described herein relate to a biometric system for determining identity of a subject using a single-frame silhouette, the biometric system including: a data interface configured to receive a silhouette image; a non-transitory memory configured to store specific computer-executable instructions; and an electronic processor in communication with the non-transitory memory and configured to execute the specific computer-executable instructions to at least: generate a distance transformed image using the silhouette image; generate a representation image using the distance transform image, the representation image including features corresponding to a skeleton of the subject; extract a vector embedding of the representation image using a recognition model; and determine the identity of the subject by a reference vector embedding and the vector embedding.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the following description of the various embodiments, reference is made to the accompanying drawings which form a part hereof, and in which is shown by way of illustration various embodiments of the device. It is to be understood that other embodiments may be utilized, and structural changes may be made. It should be understood that the diagrams are not drawn in scale and certain dimensions may have been exaggerated for clarity and/or emphasis.

FIG. 1 Schematically illustrates an example identification system configured to identify an entity in a raw image by generating a score indicative of level of similarity between the imaged entity and a known entity in accordance with certain embodiments.

FIG. 2A schematically illustrates an example implementation of the feature representation pipeline of the identification system shown in FIG. 1, configured to receive an inverse silhouette image and generate a distortion invariant representation of the body (DIRB) in accordance with certain embodiments.

FIG. 2B is a flow diagram illustrating an example process that may be used by the identification system shown in FIG. 1 to generate the DIRB image in accordance with certain embodiments.

FIG. 3A schematically illustrates example algorithms, functions and data types in the recognition and optimization models used in the score generation pipeline of the identification system shown in FIG. 1 in accordance with certain embodiments.

FIG. 3B is a flow diagram illustrating an example process that may be used by the identification system shown in FIG. 1 to generate a matching score for the DIRB image generated by the process shown in FIG. 2B in accordance with certain embodiments.

FIG. 4 is a block diagram illustrating the process of matching score calculation and ID generation in the identification system shown in FIG. 1 in accordance with certain embodiments.

FIG. 5 schematically illustrates an example difference of Gaussians pyramid that can be generated by a multi-scale representation module of the identification system shown in FIG. 1 in accordance with certain embodiments.

FIGS. 6A-6B illustrate an example silhouette image (6A) and difference of Gaussians (DoG) images (6B) generated using the silhouette image in accordance with certain embodiments.

FIGS. 7A-7B illustrate the distance transformed (DTx) image (7A) computed using the silhouette image shown in FIG. 6A and DoG images (7B) generated using the DTx image in accordance with certain embodiments.

FIG. 8 is a block diagram illustrating a pair of score generation pipelines each configured to process one of two DoG images, selected from the DoG images in FIG. 7B, to generate individual matching scores that are fused to generate a single matching score in accordance with certain embodiments.

FIGS. 9A-9E are example inverse silhouette images of a human subject before (bottom row) and after augmentation top row) in accordance with certain embodiments.

FIG. 10 shows example raw images (RGB images) of a human subject (top row) and the corresponding inverse silhouette image (Bₛᵢₗ), distance transformed (DTx) image, and distortion invariant representation of the body (DIRB) image (Bₛₖₑₗ) derived from the respective raw image (first, second, and third tows below the top row, respectively) in accordance with certain embodiments.

FIG. 11 schematically illustrates a biometric image generation system (or network) configured to receive a raw image of a human subject and use the raw image to generate a composite biometric image of the human subject by generating and integrating a shape-based biometric image and an enhanced parsed image of the human subject in accordance with certain embodiments.

FIG. 12 shows an example raw image of a human subject and its transformation to a corresponding DIRB and enhanced parsed images that are integrated to generate an outfit regularizing biometric (ORB) image in accordance with certain embodiments.

FIG. 13 schematically illustrates a portion of an identification network comprising three score generation pipelines each processing one of RGB, DIRB and enhanced parsed images of a human subject to generate a matching score by fusing individually calculated matching scores or by fusing intermediate outcomes from individual pipelines and calculating the matching score based on the fused intermediate come in accordance with certain embodiments.

FIGS. 14A-14B show fourteen example RGB images (top row) of a human subject captured under various distortive conditions and the corresponding DIRB images (second row from top, Bₛₖₑₗ), enhanced parsed images (third row from top, EP), and ORB images (bottom row) generated using the respective RGB images in accordance with certain embodiments.

FIGS. 15A-15B show calculated true accept rate plotted against false accept rate (15A) and calculated identification rate plotted against rank (15B) for results obtained using one of the disclosed embodiments based on a first evaluation protocol (EP3.1) in accordance with certain embodiments.

FIGS. 15C-15D show calculated true accept rate plotted against false accept rate (15C) and calculated identification rate plotted against rank (15D) for results obtained using one of the disclosed embodiments based on a first evaluation protocol (EP4.2) in accordance with certain embodiments.

### DETAILED DESCRIPTION

### Introduction

Identifying and recognizing an entity based on an image or multiple images (e.g., associated with a video recording) captured from a long range, by an elevated and/or aerial sensor platforms, or other conditions that can reduce the quality and clarity, of the image(s) or visibility of certain portions of the entity that contain useful information for identifying the entity (biometric information), can support and/or enable a wide range of applications including surveillance, virtual reality, authentication, smart systems, and the like. Moreover specifically, recognizing human subjects across cameras mounted on various platforms and under diverse imaging conditions is of significant interest in any of the above-mentioned applications.

In some cases, an image-based identification system (herein referred to as identification or identification system) may compare a raw or processed image of an unknown entity (e.g., a human subject) with a plurality of raw or processed reference images of known entities to identify the unknown entity by finding a match between the image and a reference image from the plurality of reference images. In some cases, the match may be found by generating a plurality of matching scores based on comparisons between the image and different ones of the reference images and using the matching scores to select the best match for the image. In some implementations, the identification system may use an appearance-based (e.g., face-based) method, a shape-based (e.g., body-based) method, or a combination thereof, to recognize the unknown entity. In some cases, e.g., when a portion of the entity associated with its appearance captured in an image is not sufficiently clear, a shape-based method may be used instead or in combination with the appearance-based method.

Existing image-based identification systems can use different identification methods and/or biometric image modalities for identifying an entity (e.g., a human subject) in one or more images. Gait identification method and RGB-based identification method are two examples of such methods. In some cases, a gait identification system may capture video footage of a moving subject and then analyze the video frames to extract various features including movement patterns to create a unique gait signature. As such, in some cases, the gait identification system may use temporal information associated with multiple frames to extract biometric features. In some cases, a gait recognition method may comprise identifying a human subject by analyzing his/her movement using a plurality of images (e.g., multiple frames in a video recording). In some examples, the movement may comprise a walking pattern where variables such as step width, stride length, and foot angle are quantified and analyzed to derive a set of biometric parameters that can be compared to those of known subjects. Gait methods may not accurately recognize a subject when the number of available images (e.g., video frames) are too small (e.g., 1-3 5-10 frames per video) to allow derivation of a reliable biometric parameter. For example, a gait system may not be very effective when an unknown subject has to be identified based on a single image/frame or a plurality of images/frames captured at random times. Furthermore, the gait method may require excessive computational resources as it involves additional steps, e.g., compared to RGB-based methods, such as image registration.

In some cases, an RGB-based identification method may use color images, having the red, green, and blue color channels therein, to identify an entity (e.g., a human subject or an object). In some implementations, the RGB-based identification method may comprise analyzing color and texture information in an image. In contrast to the gait identification methods, RGB-based identification methods may identify a subject using a single image or single frame of a video and thereby allow recognition of an entity using less computational resources compared to the gait identification methods.

In various applications, due to their lower computational cost, there is considerable interest in image-based identification methods that can identify an entity using a single or limited number of images or frames (e.g., RGB-based identification methods). However, the efficiency and accuracy of some of the methods (e.g., appearance-based methods) can be affected by certain conditions, herein referred to as distortive conditions, which can make discerning facial or other appearance-based biometric features very difficult, and in some cases, impossible.

In various examples, a distortive condition may comprise capturing the image from a long distance and/or under other conditions that may not allow capturing clear images comprising highly distinct characteristics usable to identify the entity. For example, a distortive condition may comprise an environmental condition (e.g., turbulent atmosphere, lighting, visibility, and the like), a condition of the entity at a time of capturing the image (e.g., orientation with respect to the camera, clothing or cover, movement, and the like). In some examples, the distortive condition may comprise a characteristic of the imaging system (e.g., resolution, camera jitter, pan angles, articulation, and the like) or a position of the imaging system with respect to the subject (e.g., large and/or unstable separation between imaging system and imaged subject), which may prevent the imaging system from generating an image with sufficient clarity for appearance-based identification. For example, image of a human captured from a long distance in a low visibility condition (e.g., dust, fume, fog, and the like) may not include sufficient facial information to allow face-based recognition. In some cases, a long distance with respect to capturing an image that is not clear enough for appearance-based entity recognition (e.g., human subject identification), can be from 50 to 100 meters, from 100 to 200 meters, from 200 to 300 meters, from 300 to 500 meters, from 500 to 700 meters, from 700 to 1000 meters, or any ranges formed by these values or longer. As another example, at a given distance and environmental condition, one or both the optical arrangement and image sensor of a camera may not allow generating an image with sufficient resolution for resolving, a face (or another portion) of a human subject or a characteristic of an object, which may be used to uniquely identify the human subject or the object. Yet as another example, available images of a human subject may not allow appearance based (e.g., face-based) identification due to an orientation (e.g., a facial orientation) of the human subject with respect to an aperture of the corresponding imaging system during an imaging or recording period.

In addition to distortive conditions described above, which affect individual images, variations in imaging platforms (ground-based versus aerial-based), images captured by diverse image sensors, changes in subject's clothing in different images, arbitrary poses in different images, occlusion and articulation of the subject's body in different images, and other conditions that can make discerning certain biometric features (e.g., facial features) from multiple images or comparing certain biometric features in two different images (e.g., a probe image and a reference image), a challenging task. In some cases, a probe image can be an image comprising an unknown entity and a reference image (also referred to as a gallery image) may comprise a known subject. In what follows, conditions that adversely affect the identification process by reducing clarity of individual images or generating variation of observable biometric features over multiple images, are collectively referred to as distortive conditions.

In some embodiments, shape-based identification methods that rely on shape of a portion or entire body of a subject, instead of details localized in small region, may facilitate identification process when one or more images (e.g., two-dimensional images) used for the identification process comprise a distortive condition. However, shape-based identification methods may not allow identification with sufficient accuracy and may be still affected by a distortive condition, in particular when the identification is based on a single image or a small number of images. Moreover, a shape-based method can be complex and may require excessive computational resources.

As such, there is a need for robust, accurate, and low complexity human identification methods for identifying subjects based on images captured under distortive conditions. More specifically, there is a need for image processing and identification methods that at least partially rely on shape-based identification and can identify subjects based on a single or a small number of two-dimensional images captured under distortive conditions.

Some of the disclosed methods comprise providing an auxiliary representation of at least a portion of a single-frame shape-capturing image of an entity (e.g., the human subject) extracted from a raw image (e.g., raw two-dimensional image) captured under a distortive condition. Different types of images that represent and highlight the shapes, contours, or outlines of objects and subjects in various ways may be collectively referred to as shape-capturing images. Through lines, shadows, or digital paths, shape-capturing images may emphasize the form and structure of the subject. In some cases, the shape-capturing image can be a black and white body image, where white pixels correspond to human body and black pixels correspond to a background.

In some embodiments, the auxiliary representation of raw image may enhance or highlight certain shape-based biometric features of an entity captured in the raw image. In some cases, auxiliary representation may comprise a shape-based (e.g., body-based) biometric, herein referred to as shape-based biometric image, extracted from the shape-capturing image and usable for recognizing a human subject.

A shape-capturing image that can be robust to these challenges imposed by a distortive condition and provide computational efficiency is the single-frame binary silhouette or inverse silhouette (Bₛᵢₗ) of a person.

In some embodiments described below, the shape-capturing image may comprise a silhouette or an inverse silhouette image derived from a raw image, and the auxiliary representation may be generated by performing a process, comprising a transformation (e.g., a distance transformation) and difference of Gaussians (DoG) computation, on the shape capturing image. In some cases, a shape-based biometric image may comprise a feature that may not be distinguishable (e.g., easily observable) in the raw image and/or the shape-capturing image and is usable for identifying the entity.

In some embodiments, shape-based biometric image can be a shape-based feature descriptor of a human body generated using a single binary frame of a human body. For example, a black and white silhouette image of a human body may be used to generate an estimate of the skeleton of human body or a skeleton-like pattern associated with the human body.

More generally, in some embodiments, the proposed methods may enable recognizing or identifying an entity (e.g., a human, an animal, or an object) using a raw image comprising the entity (e.g., raw images captured under a distortive condition), by extracting a shape-based attribute of the entity from the raw image and comparing it to a plurality of reference shape-based attributes extracted from a gallery of reference images of known entities.

Some of the recognition methods described below include compact and modular models and frameworks that can provide a robust performance against image distortions. Some of these models and frameworks can be used as standalone models or can be combined with an existing model to enhance the existing model and to enable a more accurate and robust identification process, especially when an unknown subject has to be identified in an image captured under a distortive condition.

The results presented below under heading “Implementations and Results” include quantitative evaluation of the performance of some of the proposed methods and models using custom data sets (e.g., long-range datasets) such as those provided by Biometric Recognition and Identification at Altitude and Range (BRIAR) program of intelligence advanced research projects activity (IARPA). These results demonstrate the robustness of the disclosure methods, pipelines, and algorithms in the presence of certain common challenges of video-based recognition. Some of the disclosed methods (e.g., single-frame methods) are compared against gait methods using small number of frames (e.g., less than 10 frames). Performance of some of the disclosed methods are compared to grayscale models in the presence of variation of range, environment, and clothing. The results indicate that shape-based biometric images generated using some of the disclosed methods can improve the performance of an identification system compared to grayscale images. In some examples, the disclosed models can improve the performance of a baseline grayscale model by over 15%.

Advantageously, in contrast to gait methods, some of the disclosed methods and models allow identification of an entity (e.g., a human subject) using a single-frame silhouette or a single inverse silhouette image, extracted from a raw image, that does not include temporal information.

In some embodiments, the shape-based biometric image may be used to train a machine learning model (e.g., a deep-learning-based human recognition model). In some embodiments, the trained machine learning model may be used for subject recognition based on a single image frame (e.g., human body frame) with or without supervision. Advantageously, single frame subject recognition based on the shape-based biometric image may reduce computation time and the computational resources used for subject recognition compared to some of the existing methods. In some examples, computation of a single shape-based biometric image may be performed in a short period (e.g., less than 0.7 seconds, less than 0.5 seconds, less than 0.3 seconds, less than 0.1 second or lower values).

As mentioned above, one of the challenging aspects of human recognition is the variability in clothing in different images used for recognizing a human subject (including probe and reference images). For example, the appearance of a human subject appear with different attires in a probe image (e.g., a raw image) and a corresponding reference image (e.g., a reference raw image) can significantly increase the difficulty of detecting the similarity between the image of the subject in the probe and reference images.

As described above, some of the disclosed methods and systems described below provide distortion-invariant body biometrics and processing pipelines for generating and processing these body biometrics. An example of such distortion-invariant body biometrics is the shape-based biometric image, also referred to as distortion invariant representation of the body (DIRB) image, derived from a shape-capturing image and comprising an estimated human shape or pattern derived from a single binary silhouette/inverse silhouette (a black and white body image, where white pixels correspond to human body and black pixels correspond to background).

In some embodiments, two DIRB images having different resolutions and/or scales may be used for training one or different recognition models using one or two pipelines and thereby extracting features from individual DIRB images. In some such embodiments, fusing the features extracted from individual DIRB images or fusing results of comparing features extracted from individual DIRB images with reference features may be fused to a better performance compared to some of the gait-based techniques that use 5-10 frames. Similarly, in some cases, a DIRB image may be fused with an RGB image that may comprise complementary features.

Additionally, some of the methods and systems described below provide an outfit regularizing biometrics and processing pipelines for generating and processing them. An example of such outfit regularizing biometrics is an outfit regularizing biometric (ORB) image that combines identity-preserving features of a human body corresponding to exposed body parts and covered body parts into a single, comprehensive image representation.

In some embodiments, to generate an ORB image, first the DIRB is derived from a raw image and then the ORB image is generated using the DIRB image and the raw image. The disclosed DIRB images, ORB image, and the corresponding biometric image generation and processing algorithms can be light weight and may enable modular implementation and thereby can be combined with existing recognition pipelines with little effort.

Some of the proposed systems and methods may identity a subject based on two or more of the raw images, and the corresponding DIRB and ORB images, by fusing information extracted from these images at different levels (e.g., score-level, feature-level, and the like). For example, some of the disclosed methods comprise extracting feature embeddings from multiple image modalities, e.g., the ORB image, in combination with one or both a raw image (or other appearance-based image) and the shape-based biometric image (DIRB image), and fusing the extracted feature embeddings or individual matching scores generated using the extracted feature embeddings. In some cases, the method may comprise using multiple processing transformer-based pipelines, collectively referred to as a TransFuse pipeline, for processing multiple images (raw and biometric images).

In some cases, fusion of the proposed biometric images with existing biometric representations, e.g., using the TransFuse pipeline, can improve existing identification systems and make them faster and/or more accurate.

The proposed biometric image modalities and processing pipelines are modular, and compact, and capable of being used independently or integrated as plug-and-play components with other methods to enhance the performance of long-range human recognition under extreme imaging conditions.

The results presented below (in the “Implementations and results” section), which include numerical evaluation of subject recognition using multiple images (including ORB and DIRB biometric images) and TansFuse pipelines, demonstrate the robustness and efficiency of the proposed methods in tackling extreme imaging challenges such as clothing change, environment change, pitch, pose variation, articulation, turbulence, camera elevation, and more, outperforming recognition methods based on RGB images, by nearly 15-18% on a BRIAR setup.

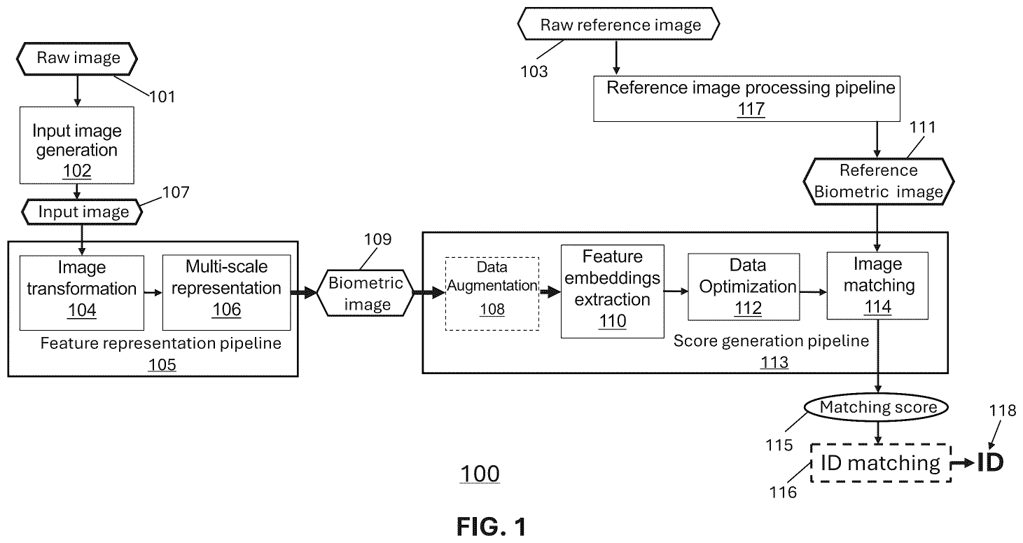

FIG. 1. Schematically illustrates a identification system (or network) 100 configured to identify an imaged entity in a raw image 101 (e.g., color, grayscale, or black and white image), by generating an auxiliary representation of the raw image 101 and generating a matching score 115 indicative of a matching level between the auxiliary representation and auxiliary representation of a reference image derived from a raw reference image of a known entity. In some cases, the auxiliary representation of the raw image may comprise a biometric image 109 (e.g., a shape-based biometric image) and the auxiliary representation of the reference image may comprise a reference biometric image 111 (e.g., a reference shape-based biometric image). In some cases, the identification system 100 may generate an input image 107 using the raw image 101 and generate the biometric image 109 by processing the input image 107. In some embodiments, the identification system 100 may comprise a shape-based recognition process configured to generate a matching score 115 based on a shape-capturing image derived from the raw image 101.

In some embodiments, the identification system 100 may comprise a non-transitory memory storing machine-readable instructions and a hardware processor configured to execute the machine-readable instructions to process the raw image 101 to generate the matching score 115 for an entity in the raw image 101.

In some embodiments, the identification system may comprise a plurality of software modules (herein referred to as modules), each configured to perform a computational task comprising processing data derived or extracted from the raw image 101.

In some embodiments, the raw image 101 can be a digital image generated by a digital image sensor when an optical image of a scene comprising the entity is projected on the digital image sensor by an optical system. In various implementations, the raw image 101 can be a sole image of an entity captured by an imaging system, one of a plurality of images captured by one or different imaging systems, a frame in a video recording captured by a video recording system (e.g., a video camera, a surveillance system, a network video recorder, and the like). In some cases, the raw image 101 may be received from an imaging system, a database, or a server, separate from the identification system 100, via wired or wireless link. For example, a computing system may receive a raw image from an imaging system, process the raw image to generate the input image 107 and transmit the input image to the identification system 100 for further processing and generation of the matching score 115.

In some embodiments, the identification system 100 may comprise an input image generation module 102 configured to receive the raw image 101 and generate the input image 107. In some cases, the input image 107 may comprise a shape-capturing image depicting a shape of an entity in the raw image. In some embodiments, the input image 107 may comprise a silhouette image or inverse silhouette image extracted from the raw image 101. As described above, a silhouette image is an example shape-capturing image that can be used to recognize an entity in an image captured under a distortive condition. In some cases, the silhouette image or inverse silhouette image can be binary images comprising black and white pixels. For example, an inverse silhouette can be a black and white body image, where white pixels correspond to a human body and black pixels correspond to a background.

In some implementations, the input image generation module 102 may comprise a human detection process that detects a human subject in the raw image 101, a silhouette extraction process that generates a silhouette image of detected human subject, and a process which computes an inverse silhouette image of the human subject using the silhouette image. In some cases, these processes may be performed using existing methods, models and/or software packages (e.g., commercially available software packages).

Advantageously using a silhouette or inverse silhouette images as the input image 107 may reduce computational cost of the recognition process. Since many recognition models perform human detection and silhouette extraction as primary steps, using a silhouette or inverse silhouette images may simplify integration of the proposed recognition process with other models and processes. Furthermore, the impact of long-range imaging and clothing variation may be lower when the input image comprises a silhouette or an inverse silhouette image since these images may not be affected by blurring of face or body at distances and changing color of clothes.

In some embodiments, the identification system 100 may be configured to generate the matching score 115 using a raw image 101 comprising a single frame. Advantageously, identification of an entity using a single-frame, and the corresponding single frame silhouette or inverse silhouette, can simplify the identification process and reduce the computational complexity of the system, e.g., by eliminating the need for image registration and/or temporal aggregation, which may be performed when multiple frames (e.g., associated with a video recording) are used for entity dentification. For example, storing and processing a single frame requires less memory and can be performed faster compared to full video frames (a property useful for real-time identification of an entity).

In some cases, the impact of camera jitter and motion blur on a single-frame silhouette (or inverse silhouette) can be much lower than their impact on video images. Moreover, entity identification based on a single frame may facilitate integrating or combining the proposed recognition method with existing methods and models (e.g., gait recognition or RGB models) and thereby performance of the existing models and methods by using the proposed recognition method as a bootstrap (in particular when the raw image 101 or a video recording is captured under a distortive condition).

In some embodiments, the identification system 100 may comprise a feature representation pipeline 105 and a score generation pipeline 113, where each pipeline comprises two or more modules configured to process received data from a previous pipeline or module.

In some implementations, the feature representation pipeline 105 may be configured to receive the input image 107 from the input image generation module 102 and generate the biometric image 109 as an auxiliary representation. In some embodiments, the feature representation pipeline 105 may comprise an image transformation module 104 configured to transform the input image 107 using an image transformation algorithm. In some cases, the image transformation algorithm may comprise a distance transform and the transformed image may comprise a distance transformed image (herein referred to as DTx image). In some cases, the DTx image may comprise certain geometrical and/or structural characteristics of the imaged entity that may not be easily distinguishable in the raw image and the input image (e.g., an inverse silhouette image).

In certain embodiments, performing a distance transform on a silhouette or inverse silhouette image of the entity (e.g., human subject) may provide a distance transformed image comprising features capturing certain characteristics of the entity (e.g., features corresponding to the skeleton of a human subject) useable for identifying the entity. In some cases, the distance transform may comprise a matrix having matrix elements representing the Euclidean distance between a pixel of the input image and a nearest boundary pixel.

In some embodiments, the feature representation pipeline 105 may comprise a multi-scale representation module 106 configured to generate the biometric image 109 by processing a transformed image (e.g., the DTx image) received from the image transformation module 104. In some cases, the biometric image 109 may comprise a representation of the corresponding input image 101, from which feature embeddings comprising essential features or characteristics of the entity, can be extracted.

In some cases, the multi-scale representation module 106 may generate a multi-scale representation of the transformed image (e.g., the DTx image). In some such cases, the multi-scale representation of the transformed image may comprise features or characteristics of the imaged entity that can be invariant to changes in scale, allowing the identification of same features regardless of their size in the image. In some cases, scaling may comprise uniform or linear transformations in image.). In some cases, the multi-scale representation of the transformed image may comprise an image herein referred to as multi-scale representation image. In some embodiments, the multi-scale representation module 106 may generate a plurality of multi-scale representation images and select a multi-scale representation image of the plurality of multi-scale representation images as the biometric image 109. In some embodiments, the multi-scale representation module 106 may select two or more multi-scale representation images as a biometric image set. In some embodiments, the multi-scale representation module 106 may generate a multi-scale representation image based on specified scale parameters and output the multi-scale representation image as the biometric image 109.

In some implementations, the multi-scale representation module 106 may compute Difference of Gaussians and the multi-scale representation image may comprise generating a Difference of Gaussians (DoG) image of the transformed image.

In some implementations, generating the multi-scale representation image may comprise generating a Difference of Gaussians (DoG) pyramid based on the transformed image (e.g., the DTx image), and selecting at least one DoG image from the DoG pyramid. In some cases, the DoG pyramid may comprise M scales and N octaves and thereby M×N multi-scale representation images.

In some embodiments, at least some of the DOG images in a DoG pyramid generated using the DTx image derived from the raw image 101 of a human subject, may provide a coarse joint representation of the human subject's body or a skeleton-like pattern associated with the human subject (e.g., corresponding to the skeleton of the human subject). In some embodiments, the coarse joint representation may comprise biometric information usable for identifying the human subject.

In some embodiments, the score generation pipeline 113 may be configured to receive the biometric image 109 (e.g., a multi-scale representation image) from the feature representation pipeline 105 and generate the matching score 115 indicating a level of similarity between the imaged entity in the raw image 101 received and a raw reference image 103 of a known entity. In some examples, the raw reference image may be received from a gallery comprising a plurality of references images of the known entity.

In some embodiments, the score generation pipeline 113 may comprise a feature embedding extractor module, 110, a data optimization module 112, and an image matching module 114. In some cases, the biometric image 109 generated by the feature representation pipeline 105 may be serially processed by these modules to generate the matching score 115. In some embodiments, the score generation pipeline 113 may further comprise an augmentation module 108 (e.g., a data augmentation module) configured to augment the biometric image 109 and provide the resulting augmented biometric image to the feature embedding extraction module 110.

The feature embedding extraction module 110 may be configured to receive the biometric image 109 received from the multi-scale representation module 106 or the augmented biometric image received from the augmentation module 108, and extract feature embeddings associated with the imaged entity using a recognition model. In some cases, the recognition model may comprise a neural network model configured to extract feature embeddings from the biometric image 109 or the augmented biometric image. In some examples, the neural network model may comprise a multi-layer high resolution network (HR-Net) that may be configured to perform repeated multi-scale feature concatenation to hierarchically fuse high-resolution and low-resolution features and thereby generate a semantically strong and spatially precise feature embeddings. In some cases, an extracted feature embedding may comprise a vector that captures distinguishing features and characteristics of the imaged entity. In some cases, the process of extracting feature embeddings may comprise training a neural network model (e.g., the HR-Net) to learn an optimal representation of the auxiliary image in a latent space.

The data optimization module 112 may be configured to optimize the latent space associated with the extracted feature embeddings. In some cases, the optimization module 112 may use a loss function configured to perform multi-objective optimization, to optimize the latent space. In various implementations, optimizing the latent space may comprise capturing more relevant features of the data, allowing for smooth interpolation between points, making the learned features more interpretable, making the representation more compact, reducing the complexity and computational cost of the model, and like.

In some embodiments, the data optimization module 112 may be further configured to minimize a distance between two latent space representations of the same subject (e.g., different poses, or indoor vs outdoor image) and maximize distance between the vectors associated with different subjects.

The image matching module 114 may be configured to receive the extracted feature embeddings from the feature embedding extraction module 110 or data optimization module 112, receive a reference feature embedding (also referred to as a gallery embedding) generated using a reference image, or plurality of reference images (a gallery), associated with a known subject, and generate the matching score 115 by comparing the extracted feature embedding and the reference feature embeddings. In various implementations, image matching module 114 may receive the reference feature embedding from a reference database or a reference image processing pipeline 117. In some examples, the reference feature embedding may have been generated using the same or similar process used to extract feature embeddings for the raw image 101.

In some embodiments, the reference image processing pipeline 117 may receive the raw reference image 103 from a gallery and use the raw reference image 103 to generate a reference biometric image 111. In some cases, the reference biometric image 111 may comprise a feature of the biometric image 109 (herein referred to as probe biometric image). In some cases, the biometric image 109 and the reference biometric image 111 may comprise a common feature associated with a multi-scale representation.

In some embodiments, the reference feature embedding may be generated by generating a plurality of individual reference feature embeddings using a plurality of reference raw images and aggregating the plurality of reference feature embeddings (e.g., using averaging) to obtain an aggerate reference feature embedding. In some such embodiments, the image matching module 114 may compare the aggregate reference embedding with a feature embedding to determine the matching score 115.

In some embodiments, the raw reference image 103 may comprise a single image of a known subject.

In some embodiments, the reference feature embedding may have been generated, at an earlier time, by deriving a reference input image using the input image generation module 102 and processing the reference input image through the feature representation pipeline 105, the feature embedding extraction model 110 and the data optimization module 112. In some embodiments, the reference feature embedding generated at an earlier time may be stored in a memory or database and provided to the score generation pipeline 113 during an identification process.

In some cases, the reference image processing pipeline 117 may comprise one or more features described above with respect to the input image generation module 102, feature representation pipeline 105, biometric image 109, and the score generation pipeline 113. In some such examples, the configurations and parameter values of a module of the reference image processing pipeline 117 can be substantially identical to those of a corresponding module in the feature representation pipeline 105 and/or the score generation pipeline 113.

In some embodiments, the image matching module 114 may be configured to compare a feature embedding corresponding to the raw image 101 and a reference feature embedding corresponding to the raw reference image 103 and generate the matching score 115. In some embodiments, the image matching module 114 may use a cosine distance between the feature embedding and the reference feature embedding.

In some embodiments, the feature embedding may comprise a vector (herein referred as vector embedding) and the reference feature embedding may comprise another vector (herein referred to as reference vector embedding) and the cosine distance may comprise a cosine similarity between the vector embedding and the reference vector embedding (e.g., a cosine of an angle between vector embedding and the reference vector embedding). For example, cosine distance can be 1−cosine similarity, where cosine similarity is the cosine of an angle between an angle between vector embedding and the reference vector embedding).

As described above, in some embodiments, the identification system 100 may further comprise an augmentation module 108 configured to process the biometric image 109 to generate an augmented biometric image. In some cases, when the feature embeddings extraction module 110 uses an augmented biometric image the robustness and reliability of the feature extraction process in the score generation pipeline 113 may be improved. For example, a training step of the feature extraction process can be more robust when performed on an augmented biometric image derived from the biometric image 109 compared to another training step directly performed on the biometric image 109.

In some embodiments, the feature representation pipeline 105 may generate two or more biometric images each comprising a different auxiliary representation of the input image (e.g., example, two DoG images having different scales or octaves). In some such embodiments, individual biometric images may be processed separately to generate corresponding matching scores. In some examples, the system may generate matching scores for two biometric images received from the feature representation pipeline 105 by processing them at different times using score generation pipeline 113. In some examples, the system may generate matching scores for two biometric images received from the feature representation pipeline 105 by processing them in parallel by the score generation pipeline 113 and another score generation pipeline (e.g., identical to score generation pipeline 113). As such, in some embodiments, the identification system 100 may comprise two or more score generation pipelines.

In some embodiments, the identification system 100 may comprise an ID matching module 116 configured to receive a plurality of matching scores and use the plurality of matching scores to identify of the imaged entity and output an ID 118 associated with a known entity. In some cases, the identification system 100 may be configured to generate the ID 118 for an entity (e.g., a human subject) using a single raw image or a plurality of raw images capturing the entity. As such, in some cases, the identification system 100 may be referred to a Single-frame Silhouette-based Recognition Network (SSRNet). In some implementations, the ID matching module 116 can be included in another system that is in communication with the identification system 100. In some such implementations, the combination of the ID matching module 116 and the identification system 100 may be referred to as SSRNet.

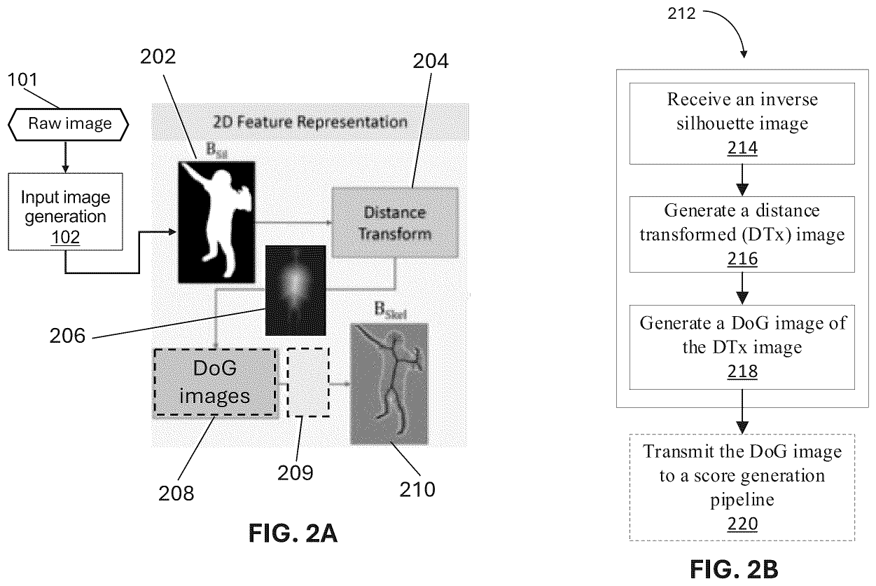

FIG. 2A schematically illustrates an example implementation of the feature representation pipeline 105 configured to receive an inverse silhouette image (Bₛᵢₗ) 202 and generate a DIRB image (Bₛₖₑₗ) 210. In this example, the image transformation module 104 comprises a distance transform algorithm 204 configured to transform the inverse silhouette image (Bₛᵢₗ) 212 to a DTx image 206 and the multi-scale representation module 106 can be configured to generate the DIRB image 210 (an example of the biometric image 109) by computing a Difference of Gaussian (DoG) image of DTx image 206 (e.g., by subtracting two images derived by passing the DTx image 206 of same/different resolutions through varying Gaussian filters).

In some embodiments, the multi-scale representation module 106 may generate a difference of Gaussian (DoG) pyramid 208 using the DTx image 206, where the DoG pyramid comprises a plurality of DoG images. In some such embodiments, the image transformation module 104 may further comprise a DIRB image selection module 209 configured to select at least one of the images in the DoG pyramid and output DIRB image 210 for identification of the unknown entity captured in the silhouette image (Bₛᵢₗ) 202.

In some cases, the Bₛᵢₗ 202 (inverse silhouette image) may be extracted from the raw image 101 comprising a frame from an RGB video, a frame from a grayscale video, an RGB image, or a grayscale image by first performing human detection on the raw image using an algorithm such as YOLOv5, YOLOv7, YOLOv8, RetinaNet, or the like. to detect one or more unknown human subjects, select one of the detected human subjects, generate a silhouette image of the selected human subject using an algorithm such as CropFormer, Mask2Former, DeepLabv3, or the like and generate Bₛᵢₗ by inverting silhouette image.

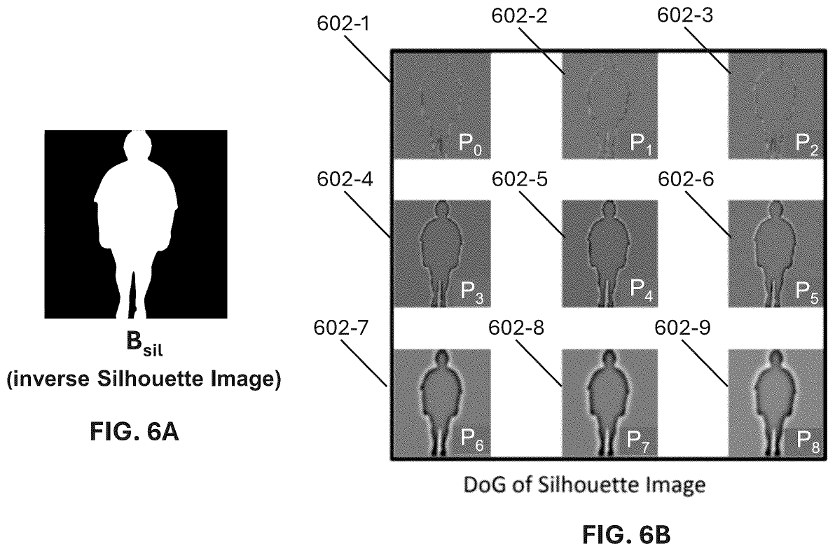

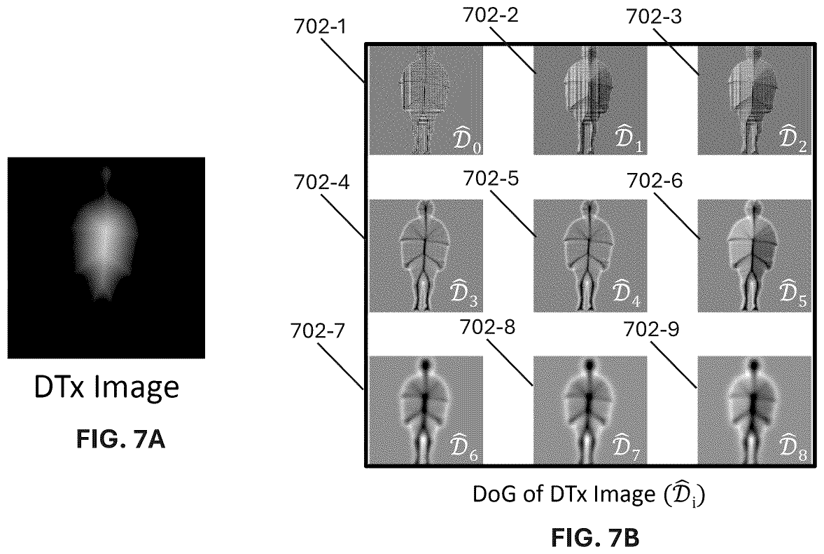

Exploratory Data Analysis (EDA) of the single-frame silhouettes (Bₛᵢₗ), comprising shape analysis, edge detection, corner detection, morphological analysis, wavelet analysis, HoG features, LBP features, SIFT features, and the like, indicate that, in some cases, when the distance transform is performed on the inverse of the silhouette, some features corresponding to the skeleton of the selected human subject can manifest. In some cases, the distance transform (DTx) image of a binary image such as Bₛᵢₗ can be a matrix of the same size as the Bₛᵢₗ, having matrix elements representing a distance (e.g., a Euclidean distance) between the corresponding pixel of Bₛᵢₗ and the nearest boundary pixel. As discussed below, with respect to FIGS. 6A and 7B, DoG pyramids generated based on both Bₛᵢₗ and the corresponding DTx image indicate that, in some cases, biometric information in images in a DoG pyramid generated based on the DTx image is significantly more compared to biometric information in a DoG pyramid generated based on the Bₛᵢₗ image.

FIG. 2B is a flow diagram illustrating an example process 212 that may be used by a processor of the identification system 100 or a subsystem therein to generate the DIRB image (Bₛₖₑₗ) 210 using the inverse silhouette image (Bₛᵢₗ) 202.

The process 212 begins at block 214 where the system receives Bₛᵢₗ 202 from the input image generation module 102.

At block 216 the system may use the Bₛᵢₗ 202 to generate the DTx image 206 (e.g., using the image transformation module), e.g., by calculating a distance for each pixel of the Bₛᵢₗ 202 using a distance metric. In some examples, the distance metric may comprise the Euclidean distance (straight-line distance between two points). However, the embodiments are not so limited, and, in some cases, other distance metrics may be used (e.g., Manhattan distance, Chebyshev distance, and the like).

At block 218 the system may generate a DoG image of the DTx image 206. In some embodiments, the system may generate the DoG image based on a specified scale and/or a specified parameter value of the Gaussian kernel (e.g., a specified Gaussian width). In some cases, the specified parameter value may be a predetermined value for a specific application, for raw images having specific characteristics, or for raw images captured under specific distortive conditions. For example, during a calibration period, multiple test DoG images may be generated using different scales and Gaussian kernels, and the test DoG images may be evaluated to determine the specified scale and/or parameter value of the Gaussian kernel for usage during an operational period.

At block 220 the system may transmit the DoG image as the DIRB image (Bₛᵢₗ) 210 representing the biometric features of the unknown human subject.

In some embodiments, at block 218, the system may generate the DoG pyramid 208 for the DTx image 206. In some such embodiments, the system may select at least one of DoG images in the DoG pyramid 208, and at block 220 the system may transmit the selected DoG image to the score generation pipeline 113.

In various implementations, DoG pyramid computation may comprise hierarchical scaling and blurring of the DTx images using varying Gaussian kernels. Computing the scale-invariant feature descriptor of the example DTx indicate that at least some of the DoG images in the DoG pyramid may provide coarse joints information for the unknown human subject captured in the corresponding Bₛᵢₗ. In some implementations, the DoG pyramid may comprise a plurality of DoG images distributed in multiple octaves each comprising several scales. In some cases, each of the plurality of images may comprise different types of biometric features. In some cases, a DoG image or the DoG pyramid may comprise a scale-invariant feature descriptor.

In some embodiments, at block 218, the system may generate more than one DoG image or may select more than one DoG image from the DoG pyramid, as a set of DIRB images representing the biometric features of the unknown human subject. In some examples, using two or more images may improve the accuracy and reliability of a subsequent identification process, e.g., by capturing more biometric features (e.g., complementary features). In some embodiments, a DIRB image set comprising the two DoG images having different resolutions (e.g., the highest and the lowest resolutions) may support an identification process with sufficient accuracy. While adding more DoG images DIRB image set may further improve the identification process, the additional computational cost associated with processing the additional images in the score generation pipeline may not justify the additional improvement. In some embodiments, a single DIRB image judiciously selected from the plurality of the images in the DoG pyramid, can support an identification process with sufficient accuracy for a wide range of applications. In some cases, the single DIRB image can be an image with average resolution or an image having above average resolution but not necessarily the highest resolution. In some embodiments, two, three or more DIRB images may be selected from the plurality of the images in the DoG pyramid. In some cases, these images can include an image with a high resolution and image with a low resolution and an image with average resolution between the high and low resolutions.

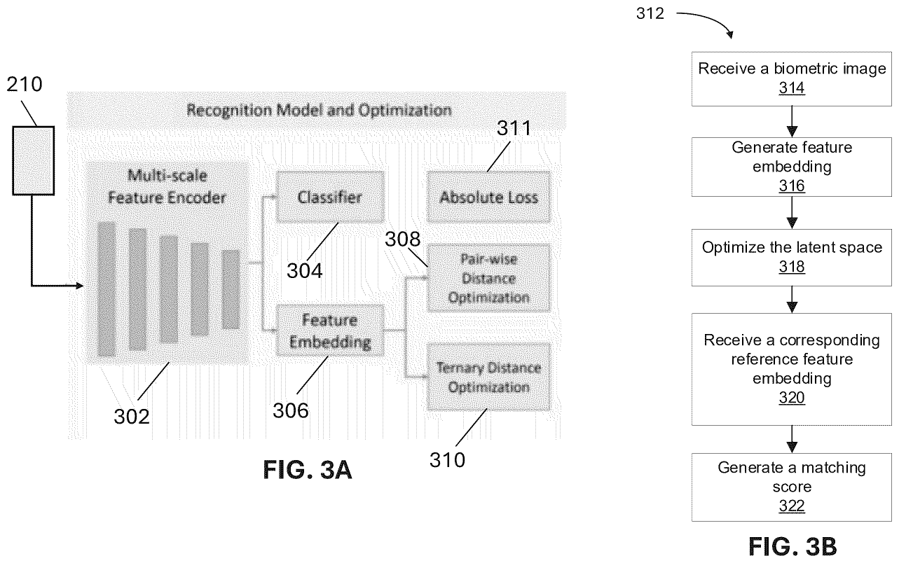

FIG. 3A schematically illustrates example algorithms, functions in the recognition and optimization models used by feature embedding extraction module 110 and the data optimization module 112 of the score generation pipeline 113, to extract feature embeddings from the DIRB image 210 and optimize the extracted feature embeddings for image matching. In this example, the feature embedding extraction module 110 comprises a multi-scale feature encoder 302, and the data optimization module 112 can be configured to perform multi-objective optimization using multiple loss functions. In some embodiments, the multi-scale feature encoder 302 may comprise two linear layers, a first layer that outputs a classifier 304 and a second layer that outputs feature embeddings 306. In some embodiments, the optimization process may comprise a pair-wise distance optimization 308 and ternary distance optimization 310 of the extracted feature embeddings 306 and determination of an absolute loss 311.

FIG. 3B is a flow diagram illustrating an example process 312 that may be used by a processor of the identification system 100 or a subsystem therein to generate a matching score indicative of a similarity between the unknown entity captured in the input image from which the DIRB image 210 is derived, and a known entity in a reference raw image or the corresponding input image.

The process 312 begins at block 314 where the system receives Bₛₖₑₗ 210 (or another biometric image) from the feature representation pipeline 105.

At block 316 the system extracts feature embeddings from the Bₛₖₑₗ 210 using a recognition model. In some examples, the recognition model may comprise a multi-layer (e.g. 30-layer) High-Resolution Network (HR-Net) architecture. In some cases, an auxiliary representation (e.g., Bₛₖₑₗ 210) derived from a raw image may comprise more information (e.g., discriminatory information) compared to a shape-based image (e.g., Bₛᵢₗ). derived from the same raw image. In contrast to HR-Net, when the level of abstraction increases, the feature descriptors of Convolutional Neural Networks (CNNs), can lose some details due to the lower resolution of the features. A High-Resolution Network (HRNet) performs can repeat multi-scale feature concatenation to hierarchically fuse high-resolution and low-resolution features, thereby generating a semantically strong and spatially precise feature representation. In some embodiments, the recognition module may further include the classifier head 304 for identity classification. In some cases, the first layer of the two linear layers of the HR-Net, may generate an embedding of size 512 from the input dimension, and the second layer can have a dimension equal to the number of classes. In some examples, the output of the first layer may comprise the feature embedding 306 and the output of the second layer may comprise the classifier 304. In some cases, after the model is trained, a joint optimization may be performed over the classifier and feature embedding 306. In some embodiments, Bₛₖₑₗ 210 may be augmented, by the augmentation module 108 prior to extraction of feature embeddings. In some embodiments, when a model in the score generation pipeline is being trained on a DRIB image, augmentation may be performed on all corresponding training images DRIB images.

At block 318 the system may optimize the latent representations (e.g., minimize distance between similar classes and maximize distance between different classes) of the image data capturing the essential features and structures of the auxiliary representation. In some embodiments, the system may use a loss function to further identify differences and/or similarities between different classes in the image data that may comprise high inter-class diversity and intra-class similarity between classes/subjects and the like. In some cases, the loss function may be configured to perform multi-objective optimization. In some cases, the loss function may include multiple terms configured to recognize the similarity or dissimilarity between images or image features in the image data. For example, a first loss term may comprise absolute loss (e.g., a cross-entropy loss for the classifier) configured to differentiate between the classes in the latent space, a second loss term may comprise a pairwise loss, and a third loss term may comprise a scale- and rotation-invariant loss such as angular loss. The absolute loss may be expressed as Equation 1.

$${ℒ}_{CE} = {\sum }_{{x}_{i} ∈ ℬ} ( {y}_{i} \cdot log ( {\hat{y}}_{i} ) ) \qquad ( 1 )$$

where, yᵢ is true label and ŷᵢ is predicted label. In some examples, contrastive loss may be used as a second loss term. Advantageously, the contrastive loss may effectively differentiate between embeddings belonging to different classes and bring together the embeddings belonging to the same class. The contrastive loss may be expressed as Equation 2 below:

$${ℒ}_{con} = \frac{1}{M} \sum [ {I}_{i , j} \cdot {‖ {x}_{i} , {x}_{j} ‖}_{2} + ( 1 - {I}_{i , j} ) \cdot {[ α - {‖ {x}_{i} , {x}_{j} ‖}_{2} ]}^{+} ] \qquad ( 2 )$$

where, xₖ is the embedding vector for sample k, α is the margin for contrastive loss, I_{i,j} is the indicator function that is 1 if i=j, and −1 if i≠j, and M is batch size. In some cases, a third loss term may comprise the angular. In some cases, in contrast to a more common triplet loss, angular, which performs optimization based on cosine distance loss, may provide scale-invariance and rotation-invariance. As such, including the angular loss as a similarity transform invariant metric in the loss function may perform a rescaling of the input data features. The angular loss may be expressed as Equation 3 below.

$${ℒ}_{ang} = \frac{1}{N} {\sum }_{{x}_{a} ∈ ℬ} log [ 1 + {{\sum }_{{x}_{n} ∈ ℬ}}_{{y}_{n} \neq {y}_{a ,} {y}_{p}} exp ( {f}_{a , p , n} ) ] \qquad ( 3 )$$

where, f_{a,p,n}=4 tan²θ(xₐ+xₚ)^{T} xₙ−2(1+tan²θ)x^{T} xₚ, samples a, p and n are the anchor, positive and negative respectively, θ is the margin for angular loss, B is the batch, and N is umber of samples in a batch.

In contrast to triplet loss, which may utilize two sides of a triplet triangle, angular loss uses three sides, making it a more holistic metric. The angular loss can report faster convergence compared to triplet loss making it more scalable as the data becomes more complex. In some cases, the faster convergence of the angular loss may stem from performing the choice of margin from a smaller angular search space as opposed to the much larger space in the triplet loss case. In some cases, e.g., for more difficult-to-classify examples where the embeddings of the same class are far away or those for different classes are closer together, a combination of the second and third loss terms may be used to provide the absolute distance and angular distance between the points, respectively.

The overall loss function used for the proposed model can be expressed as Equation 4 below:

$$ℒ = \frac{1}{3} \cdot ( {ℒ}_{CE} + {ℒ}_{con} + {ℒ}_{ang} ) \qquad ( 4 )$$

At block 320 the system may receive a reference feature embedding corresponding to the feature embedding generated at block 316. In some embodiments, the reference feature embedding may have been extracted from a raw reference image (e.g., the raw reference image 103) comprising a known entity (e.g., a known human subject) generated using the same or a similar process used to extract the feature embedding from the raw image 101. In some embodiments, the reference feature embedding may be received from a non-transitory memory of the identification system 100. For example, the reference feature embedding may be extracted using the 103 raw reference image prior to extraction of the feature embedding from the raw image 101 and stored in the non-transitory memory. In some embodiments, the reference feature embedding may be received from a reference image processing pipeline (e.g., the reference image processing pipeline 117).

At block 322 the system may use the feature embedding and the reference feature embedding to generate a matching score indicative of a level of similarity between the unknown entity captured in the inverse silhouette image (Bₛᵢₗ) 202 received at block 214 of the process 212 and a known entity in a reference raw image or the corresponding reference input image from which the reference feature embedding received at block 320 is extracted. In some examples, the system may generate the matching score by computing a distance between the feature embedding reference and the reference feature embedding based on a distance metric. In some cases, the distance between the feature embedding reference and the reference feature embedding comprises a distance between two vectors each associated with one of the feature embedding reference and the reference feature embedding. In some cases, the distance metric may comprise cosine distance. However, the embodiments are not so limited, and, in some cases, the system may use a different distance metric. For example, in some embodiments, the distance metric may comprise Euclidean distance.

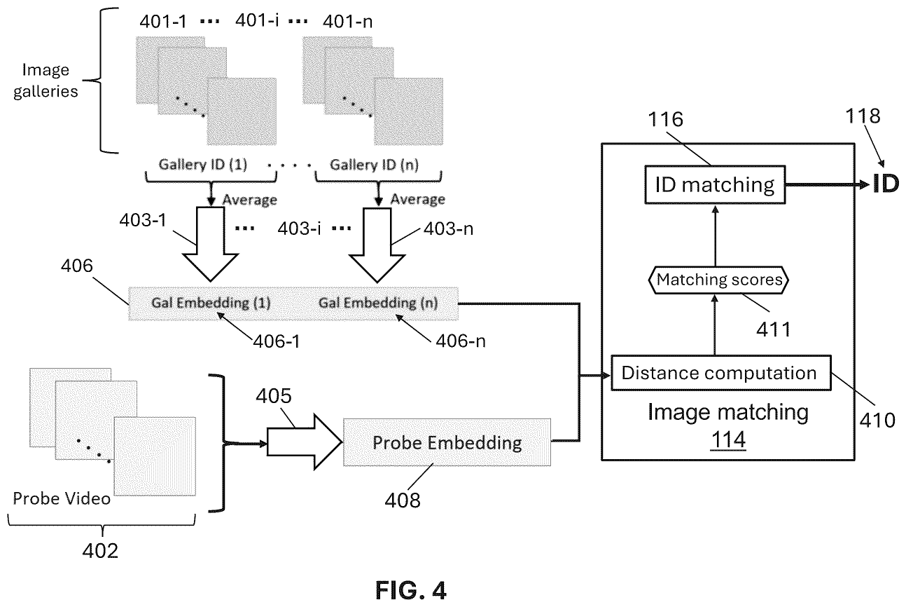

FIG. 4 is a block diagram illustrating the process of image matching and identity retrieval, e.g., by computing a matching score and generating an ID.

In some embodiments, the system may receive a probe video 402 including a plurality of image frames comprising a common unknown entity (e.g., an unknown human subject) and use a probe image processing pipeline 405 to generate a probe feature embedding, or probe embedding, 408 for the probe video 402. In some cases, the system may generate feature embeddings (probe feature embeddings) for individual frames of the probe video 402 and aggregate these frame-level embeddings to obtain the probe embedding 408 for the probe video.

In some embodiments, the system may receive a plurality of raw reference images (collectively referred as a gallery) 401-i (i=1, 2, 3, . . . , n) for a plurality of individual known entities and use a reference image processing pipeline 403-i (i=1, 2, 3, . . . , n) to generate a reference embedding (gallery embedding) 406-i using an image of from the respective gallery 401-i associated with a known entity. In some embodiments, a reference embedding 406-i may be generated using two or more raw reference images (or frames) from the corresponding gallery 401-i (e.g., by averaging the two or more raw reference images (or frames) and feeding the resulting average image to the corresponding pipeline 403-i). In some embodiments, a reference embedding (reference feature embedding) 406-i may be generated by generating a plurality of reference embeddings each extracted from one of the raw reference images in a gallery 401-i (associated with a known entity) and aggregating the plurality of reference embeddings to generate the reference embedding 406-i, which is used for comparison with a probe embedding (e.g., generated by the probe image processing pipeline 405 using a probe image, probe video frame).

In some embodiments, a reference feature embedding (reference embedding) and a corresponding probe feature embedding (probe embedding) may be generated using a common method or method having common features. For example, a reference feature embedding and a probe feature embedding that are compared to generate a matching score, may be extracted from a DoG image and a reference DOG image, respectively, where the DoG image and the reference DOG image comprise common octaves and/or common scales associated with respective DoG pyramids generated using the respective probe and reference raw images.

In some embodiments, the system may generate individual reference embeddings for individual raw reference images in the gallery (plurality of reference images) associated with a known entity and aggregate the individual reference embeddings to generate a reference embedding (gallery embedding) 406-i for the known entity.

In some embodiments, when an individual reference image gallery 401-i of the plurality of raw reference image galleries comprises an image-based dataset, the system may compute matching scores for all individual reference images, and when an individual reference image gallery 401-i of the plurality of raw reference image gallery comprises a video-based dataset, the system may compute a gallery aggregation (e.g., by averaging) before performing matching.

In various implementations, reference embeddings extracted from a plurality of reference images or video-frames in a gallery may be used individually or aggregated for performing matching, depending on performance obtain from using individual reference embedding or an aggregated reference embedding.

In some embodiments, the system may receive one or more raw images (individual probe images). In some embodiments, e.g., when multiple raw images are captured at different times and/or locations for a single unknown entity, multiple image-level embeddings may be computed independently and combined at score level (by combining individual scores associated with individual images). However, plurality of image probes (e.g., image probes having different timestamps and/or locations) may be processed individually.

In various implementations, training and evaluation processes in the pipelines 405 and 403-i may comprise image level or frame level processing and thereby may not rely on any temporal information or relation between individual frames and images. In some cases, the pipelines 405 and 403-i may comprise one or more features described above with respect to feature embedding extraction module 110 and the data optimization module 112.

In some embodiments, the image matching module 114 of the identification system 100 may compute a distance (e.g., a cosine distance) between each of the reference embeddings 406-1, . . . , 406-n (e.g., each associated with a different known subject) and the probe embedding 408 to generate a plurality of matching scores 411. In some examples, a matching score may comprise a distance between the probe embedding 408 and one of the reference embeddings 406-i.

In some cases, the system may use an ID matching module/process 116 to identify the unknown entity in the probe video 402 (or a probe image) based on the matching scores 411. For example, the system may select an optimal matching score (e.g., the highest matching score), identify the unknown entity to the known entity in the reference image gallery using which the optimal matching score is calculated, and output the identity (ID) 118 if the known entity.

In some embodiments, when the received raw images (probe images) comprise images captured at random times and/or locations, probe embeddings derived for different probe images may be used individually for image matching. In some embodiments, when the received raw images comprise video frames probe embeddings derived for different video frames may be used individually or may be aggregated prior to image matching.

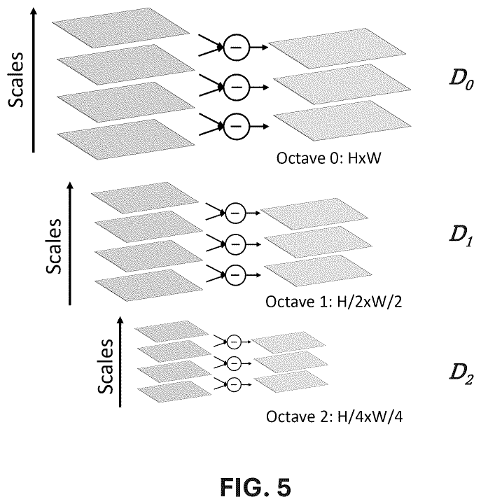

FIG. 5 schematically illustrates an example DoG pyramid (e.g., comprising DoG images 208 that may be generated by the multi-scale representation module 106). The DoG in this example includes three octaves each comprising three DoG images extracted from four Images derived from the DTx image adjusted for the respective octaves. In some cases, the DoG pyramid can be generated by hierarchical scaling and blurring of the transformed image (e.g., a DTx image) using varying Gaussian kernels. In the example shown, DoG pyramid comprises three scales (representing the sigma value of Gaussian kernels) and three octaves (representing the size of the image). As such, this DoG pyramid comprises a total of nine images.

In some cases, the DOG pyramid may be generated by local averaging and low pass filtering the resulting images having different resolutions using a series of filters (e.g., Gaussian filters). In some examples, different filters in the series of filters may provide different amounts of blur (scale). In some cases, the amount of blur may be related to the standard deviation of a corresponding Gaussian filter. In some cases, three resolutions of the intermediate image, and three sets of blurring filters for each (scale) may be used to obtain a set of nine multi-resolution images at different scales. In some cases, the standard deviation of filters may be scaled by a set factor (e.g., 2^{1/3}) to control the extent of blurring. In some cases, the scaling factor can be equal to ½^{k}, where k is the number of octaves so when an initial standard deviation is s0 (e.g., 2), the next will be s0×½^{k} and so on. In various implementations, the scaling factor and/or the initial standard deviation may be selected based on the user's preference.

In some cases, DoG pyramid may be generated by computing the difference between the images having different levels of blurs and/or different resolutions. The difference images (DoG images) may represent multi-resolution components of the DTx image at varying scales. In some examples, a DoG image of the DoG pyramid may capture certain shape characteristics (e.g., skeleton-like pattern) of a human subject at a resolution and scale different from those of other DoG images in the DoG pyramid.

FIG. 6A illustrates an example of the Bₛᵢₗ (an inverse silhouette image) derived from a raw image of a human subject. FIG. 6B illustrates nine DoG images (shown as Pᵢ's, i=0 to 8) of a DoG pyramid, similar to the DoG pyramid shown in FIG. 5, generated using the Bₛᵢₗ image in FIG. 6A. FIG. 7A illustrates the DTx computed using the Bₛᵢₗ shown in FIG. 6A. FIG. 7B illustrates nine DoG images (shown as Dᵢ(hat)'s, I=0 to 8) of a DoG pyramid generated using the DTx image in FIG. 7A. The corresponding DoG images in FIGS. 6B (602-i) and 7B (702-i) are calculated using the same Gaussian kernels and same octaves. An individual DoG image derived from Bₛᵢₗ is represented by Pᵢ and an individual DoG image derived from DTx image is represented by Dᵢ(hat)'s, where i represents the linear index of the image in respective DoG pyramids. The individual DoG images derived from a DTx image, which are represented as Dᵢ (hat)'s in FIG. 7B and some of the tables in the implementation and results section below, are herein referred to as Di's.

A comparison between the DoG images 602-1, 602-2, . . . , 602-8 derived from the inverse silhouette image (FIG. 6A) and the DoG images 702-1, 702-2, . . . , 702-8 derived from the corresponding DTx image (FIG. 7A), indicates that the DoG images derived from the silhouette image do not include biometric information more than the silhouette image itself, whereas the DoG images derived from the corresponding DTx image includes certain skeletal features comprising additional biometric information that can be usable for identifying the images human subject. As such, in various implementations of the identification system 100, one or more DoG images from the DoG images derived from a DTx (DoG images 702-1, 702-2, . . . , 702-8 in the example shown in FIG. 7B) may be used for extracting feature embeddings.

As described above, in some cases, a DRB image comprising multiple DoG images may be used for extracting feature embeddings. In some embodiments, the DRB image set may include two DoG images (e.g., one with highest resolution D₈ and lowest resolution D₀. In some embodiments, the DIRB image set may include D₇ and D₁. In some cases, other DOG image pairs may be selected and included in a DIRB image set.

In some cases, a DIRB image at block 218 of the process 212 (FIG. 2B) or the DIRB image 210 in FIG. 2A, may comprise a DoG image with average resolution (e.g., D₄).

In various implementations, a plurality of probe images, associated with a single unknown entity and/or corresponding to a common raw image (including the raw image itself), may be used for identifying the unknown entity, using the score generation pipeline 113. In some embodiments, the plurality of images can include at least one shape-based biometric image extracted from the common raw image. In some examples, the at least one shape-based biometric image may comprise a DIRB image and a DIRB image set. In some embodiments, the plurality of images can include a raw image or an augmented raw image. In some examples, the raw image may include a grayscale or an RGB image. In some embodiments, the plurality of images can include a shape-capturing image (e.g., a silhouette or inverse silhouette image).

In some embodiments, when a plurality of images are used for identifying the unknown entity, each of the images may be independently processed by a score generation pipeline (e.g., the score generation pipeline 113) at different times or by multiple score generation pipelines at the same or different times, to generate individual matching scores for individual images. In some embodiments, the image information associated with individual biometric images extracted from a common input image may be fused at feature level or score level to identify the entity. In some embodiment, score level fusion of the plurality of image images may provide more accurate results and can facilitate development of identification systems operating based on multiple image modalities. In some cases, score level fusion comprises aggregating individual matching scores generated by the score generation pipeline 113 to provide a total score. In various implementations, the total score may comprise multiplication of individual matching scores, the max value of the matching scores, the mean value of individual matching scores, or other aggregated values. In some embodiments, score-level fusion using the mean value of the scores may provide more accurate results at least compared to multiplication of individual matching scores and the max value.

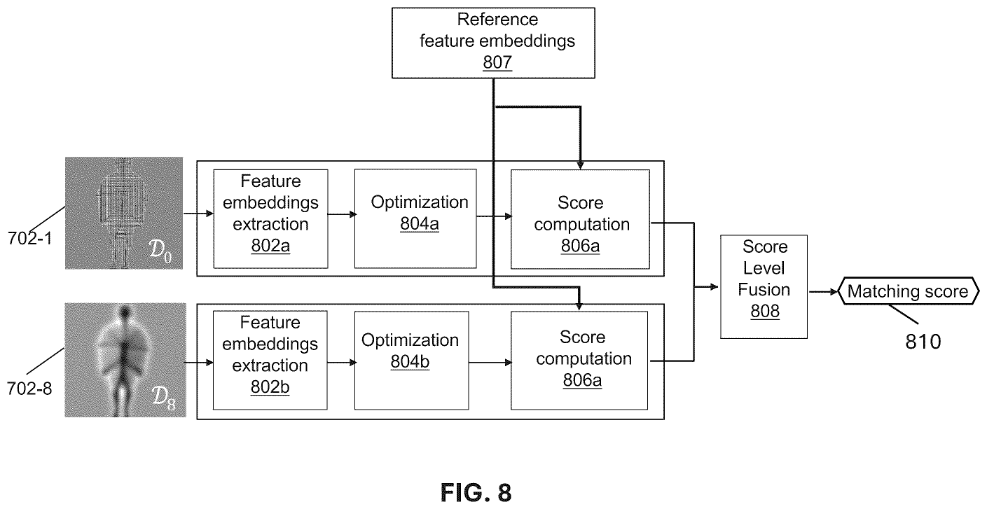

FIG. 8 is a block diagram illustrating first and second score generation pipelines each configured to receive and process one of the DoG images in FIG. 7B, to generate individual matching scores that are fused to generate a single matching score. In some examples, the two DoG images 702-a, 702-8, received by these pipelines may comprise D₈ and D₈. In some examples, illustrating first and second score generation pipelines may comprise first and second score recognition individual ones of the score generation pipelines may comprise first and second feature embeddings extraction modules 802a, 802b, first and second feature optimization modules 804a, 804b, and first and second score computation modules 806a, 806b. In some cases, the corresponding modules of the first and second score generation pipelines may comprise identical model architectures and hyperparameter values. In some examples, training the model based on different biometric images (e.g., D8 and D0 in this case), the resulting model weights can be different. In some embodiments, the first and second score computation modules 806a, 806b, may receive the same reference embedding 807 and generate first and second matching scores by determining first and second distances between first and second feature embeddings extracted from the DoG images 702-a, 702-8, respectively, and the reference embedding 807. The first and second matching scores may be combined by a score level fusion module 808 to generate a single matching score 810.

In some embodiments, the configuration and method described above with respect to FIG. 8 and score level fusion of two DoG images may be used to fuse other types of images including biometric images (e.g., shape-based biometric images), shape-capturing images (e.g., silhouette or inverse silhouette), or raw images (e.g., RGB and grayscale images). In some cases, the pair pipelines shown in FIG. 8 may be used to provide score level fusion of a DIRB image (e.g., one of the DoG images in FIG. 7B) with a grayscale image, an RGB image, an inverse silhouette image, or other images.

As described, the above augmentation (e.g., data augmentation) can play a significant role in determining the robustness of training in the feature embeddings extraction module. As such, the augmentation may accurately reflect the challenges of the dataset. In some embodiments, the augmentation module 108 may perform a linear transformation (shear, translate), perspective transforms, and random erasing. In some cases, augmentation may comprise a random dilation or erosion over a random region of the body. In some implementations, individual augmentations implemented by the augmentation module 108 may tackle a specific challenge in the training data. For example, erosion of random body parts represents effects such as distortion, whereas random erasing reflects occlusion transformations such as perspective, and shear reflects conditions such as moving camera or variation in camera pitch angle. In various implementations, other augmentation techniques may be selected and used to improve a model's ability to generalize across a variety of real-world scenarios

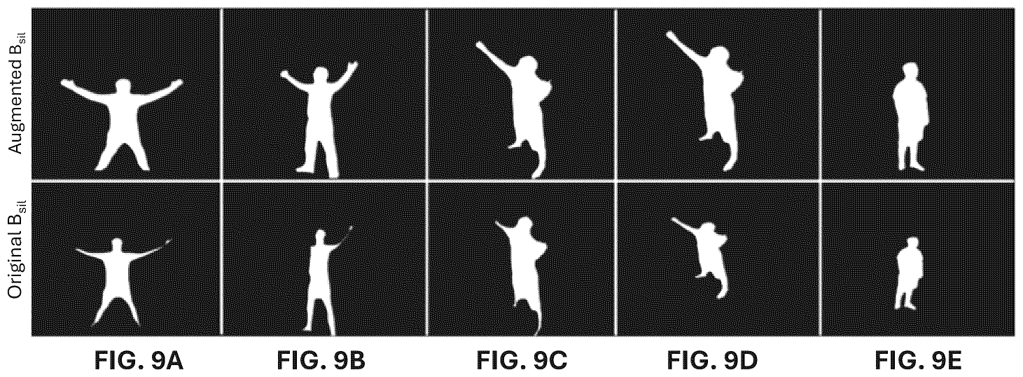

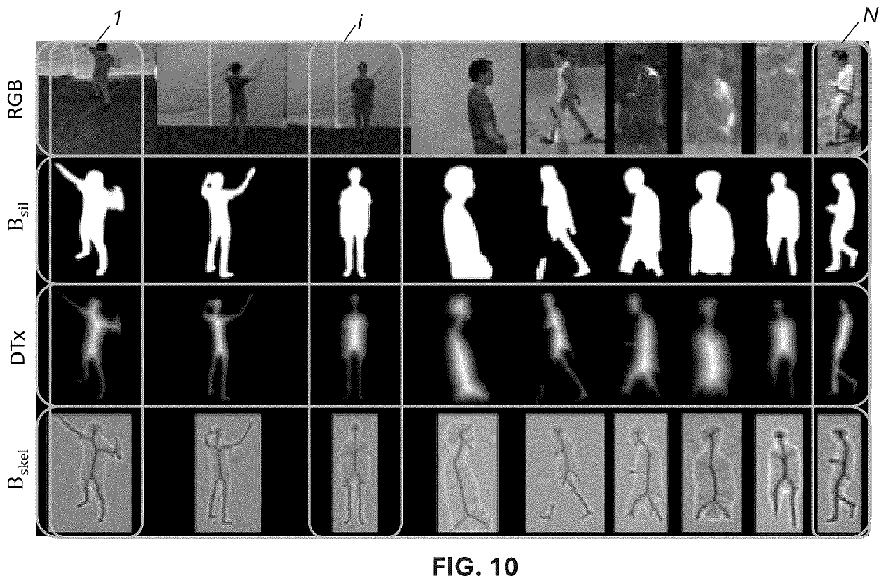

The improvements resulting from augmentation of the example distorted images are shown in FIGS. 9A-9E. In these cases, the augmentation is performed directly on the Bₛᵢₗs (e.g., inverse silhouettes), assuming that Bₛᵢₗ serves as the biometric image from which the feature embeddings are extracted. The same or similar augmentations may be performed on the biometric image 109 (e.g., multi-scale representation of a distance transformed image) by the augmentation module 108 to generate an augmented multi-scale representation of the distance transformed image that is provided to the feature embedding module 110.

FIGS. 9A-9E illustrate five Bₛᵢₗs or inverse silhouette images (bottom row) derived from raw images captured under different distortive conditions and corresponding augmented inverse silhouette images (top row) generated using different augmentation methods/models. Bₛᵢₗ's in the bottom row in FIG. 9A-9E replicate example distortive conditions and the respective augmented inverse silhouette images (top row in FIG. 9A-9E) are modified to reduce the impact of the above mentioned distortive conditions using: erosion with a small kernel (FIG. 9A), which preserves general body shape, erosion combined with erasing (FIG. 9B), which replicates occlusion, erosion with a large kernel (FIG. 9C), which replicates occlusion and distortion, perspective transform (FIG. 9D), which replicated UAV-like conditions, and perspective combined with shear (FIG. 9E), which replicated UAV-like conditions and/or moving camera.

FIG. 10 shows nine example raw images (RGB images) of a human subject and the corresponding inverse silhouette (Bₛᵢₗ), DTx, and DIRB images (Bₛₖₑₗ) derived from the respective raw image. In this example, Bₛₖₑₗ may comprise D4 in the corresponding DoG pyramid. The set of images shown in FIG. 10 represent the robustness of Bₛₖₑₗ across images captured under varying extents of distortions.

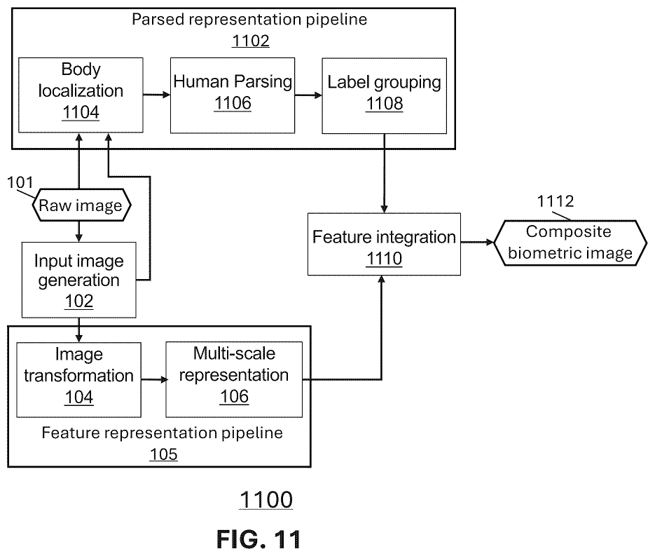

FIG. 11. Schematically illustrates a biometric image generation system (or network) 1100 configured to receive a raw image 101 and generate a composite biometric image 1112 of an entity captured in the raw image 101. In some cases, the composite biometric image 1112 generated by the system 1100 may serve as an auxiliary representation of the input image 101 for identifying the entity, e.g., using the score generating pipeline 113 of the identification system (or network) 100 or another system or pipeline. In some embodiments, the composite biometric image 1112 may comprise a feature that allows identifying the human subject independent or minimally dependent on an outfit worn by the human subject. As such, the composite biometric image 1112 is herein referred to as an Outfit Regularizing Biometric (ORB) image. In some cases, ORB image can serve as a unified body biometric that integrates certain enduring, identity-preserving attributes of shape-based and appearance-based representation for a human subject into a single image.

In some embodiments, the biometric image generation system (or network) 1100 may receive the raw image 101 from an imaging system, database, or another system, and generate an input image comprising a shape-based image. In some cases, the biometric image generation system (or network) 1100 may receive the input image from another system.

In some embodiments, the system 1100 may comprise the feature representation pipeline 105 (described above with respect to FIG. 1) configured to transform the input image to generate a DTx image and derive a multi-scale representation of the DTx image, a parsed representation pipeline 1102 configured to generate the enhanced parsed image using the raw image 101, and a feature integration module 1110 configured to combine or integrate the DTx image and the enhanced parsed image to generate the composite biometric image 1112 (or ORB image 1112).

In some embodiments, the system 1100 may comprise the input image generation module 102 (described above with respect to FIG. 1) that is configured to extract or derive an inverse silhouette image of the human subject from the raw image 101. In some embodiments, the system 1100 may receive the raw image 101 comprising an unknown human subject, transmit a copy of the raw image 101 to the parsed representation pipeline 1102, extract an inverse silhouette image of the human subject from the raw image 101, and transmit the inverse silhouette image to feature representation pipeline 105 and transmit the parsed representation pipeline 1102

In some embodiments, the system 1100 may receive the inverse silhouette image of the human subject from another system. In some such embodiments, the system 1100 may not include the input image generation module 102 or any other input image generation module.

In some embodiments, the system 1100 may receive the raw image 101 and the inverse silhouette image of human subject, transmit a copy of the raw image 101 to the parsed representation pipeline 1102, and transmit the inverse silhouette image to feature representation pipeline 105.

In some embodiments, the parsed representation pipeline 1102 may comprise a body localization module 1104, a human parsing module 1106, and a label grouping module 1108. The body localization module 1104 may be configured to receive the raw image 101 and the inverse silhouette image and isolate the human subject from the raw image. The human parsing module 1106 may be configured to receive the isolated image of the human subject (e.g., corresponding human body) identify the attire and visible body parts of the human subject, e.g., by parsing the image of the human body into body regions and clothing regions and label the identified regions. The label grouping module 1108 may be configured to receive the parsed and labeled image generated by the human parsing module 1106 group, suppress regions having labels in a first group and emphasize the regions having labels in the second group, where first and second groups are non-overlapping. For example, the label grouping module 1108 may group attires as group 1 and body parts as group 2, decrease the brightness of image pixels associated with regions in group 1, and increase the brightness of image pixels associated with regions in group 2, to generate an enhanced parsed image of the human subject.

In some embodiments, the feature integration module 1110 may receive the DTx and the enhanced parsed images of the human subject, generated by the feature representation pipeline 105 and the parsed representation pipeline 1102, respectively, and replace the pixels of the enhanced parsed image in the label grouping associated with attire (e.g., group 1) with the corresponding pixels of the DTx image and the pixels in the label grouping associated with body parts attire (e.g., group 1) with the corresponding pixels of raw image 101 to generate the biometric image 1112.

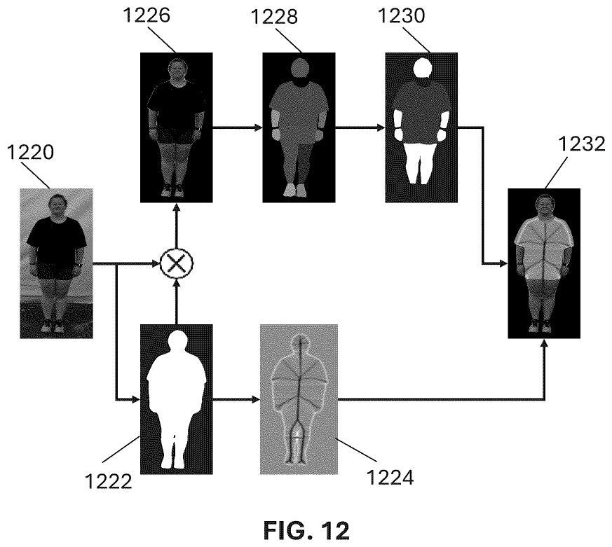

FIG. 12 shows an example raw image 1220 of a human subject, its transformation to a corresponding DIRB image 1224 and an enhanced parsed image 1230, and generation of an outfit regularizing biometric (ORB) image 1232 by the biometric image generation system (or network) 700. In some embodiments, after generation of the inverse silhouette image 1222, the body localization module 1104 may use the inverse silhouette image 1222 to isolate the human body image 1226 from the RGB image 1220 by extracting the bounding box of the silhouette image 1222, followed by a pixel-wise product of the original RGB image 1220 with the inverse silhouette image 1222.

Next, the human parsing module 1106 may use a human parsing model (e.g., a Self-Correcting Human Parsing model or SCHP model) to generate a parsed human image 1228 by identifying and labeling the attire and body parts of the human subject in the human body image 1226. In the example shown in FIG. 12, the parsed human image 1228 has been generated by training the SCHP model using the LIP dataset. In some cases, LIP data set includes 20 labels “Background: 0’, ‘Hat: 1’, ‘Hair: 2’, ‘Glove: 3’, ‘Sunglasses: 4’, ‘Upper-clothes: 5’, ‘Dress: 6’, ‘Coat: 7’, ‘Socks:8’, ‘Pants: 9’, ‘Jumpsuits: 10’, ‘Scarf: 11’, ‘Skirt: 12’, ‘Face: 13’, ‘Left-arm: 14’, ‘Right-arm: 15’, ‘Left-leg: 16’, ‘Right-leg: 17’, ‘Left-shoe: 18’, ‘Right-shoe: 19’. Subsequently, the label grouping module 1108 may transform the parsed image 1228 to an enhanced parsed image 1230 (e.g., a digital image) by: grouping the labeled parsed regions in the human image 1228 as a first group comprising labels for attire (e.g., 1, 3, 4, 5, 6, 7, 8, 9, 10, 11, 12, 18, 19 in this example) and a second group comprising labels for body parts (e.g., 2, 13, 14, 15, 16, 17 in this example), modifying the pixels associated with the first group to suppress the image regions corresponding to attires, and modifying the pixels associated with the second group to emphasize the image regions corresponding to body parts. In some cases, the pixels associated with the background (e.g., pixels not associated with the first and second groups), may be modified to suppress the background with respect to both the body parts and the attire. In the enhanced parsed image 1230, the brightness of the background pixels are set to 0, the brightness of the pixels in the first group is set to 128, and the brightness of the pixels in the second group is set to 255. In various implementations, the brightness pixels associated with background, attire, body parts may be set other values. In some embodiments, the brightness of pixels associated with body parts can be greater than the brightness of pixels associated with body parts by a first specified amount, and the brightness of pixels associated with the attires can be greater than the brightness of pixels associated with the background a second specified amount. In some cases, the first and second amounts can be provided by a user or determined by the system. In some embodiments, the feature integration module 1110 may fuse or integrate the enhanced parsed human image 1230 with a DIRB image 1224 (Bₛₖₑₗ) derived from the inverse silhouette image 1222, to generate the ORB image 1232 of the original RGB image 1220. In the example shown the DIRB image 1224 is the fifth DoG image (D₄) of a 9-image DoG pyramid determined based on a DTx image derived from the inverse silhouette image 1222. In some embodiments, the feature integration module 1110 may replace the suppressed pixels associated with group 1 with the corresponding pixels of the DIRB image 1224 and the replace the pixels associated with group 2 with corresponding pixels of the original RGB image 1220. Thus, the ORB image 1232 may tackle the clothing change issue by replacing these attributes with a robust, distortion-invariant shape biometric while preserving the original appearance-based attribute of the face, arms, and legs. Furthermore, ORB image 1232 may indirectly integrate soft biometrics via skin and hair color. The ORB image 1232 may comprise a more optimized feature representation as it maintains the identity-preserving features of the human subject in the original image 1220 while suppressing other features that may not be relevant for the identification process.

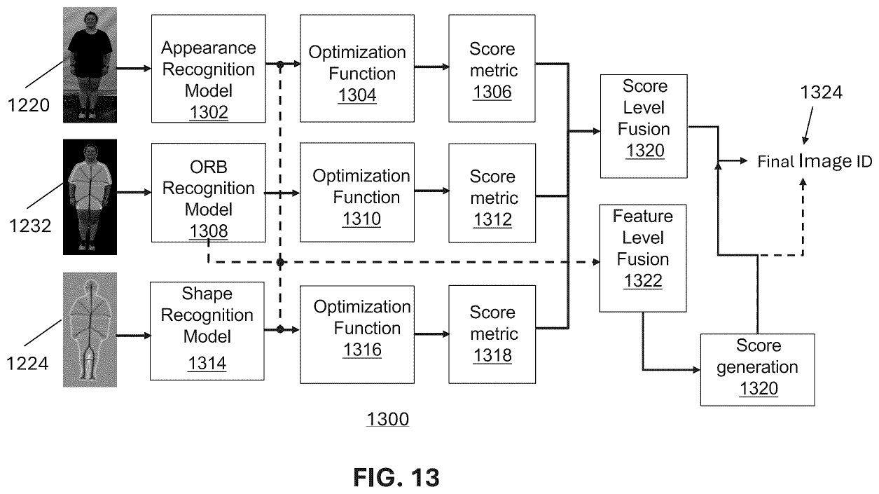

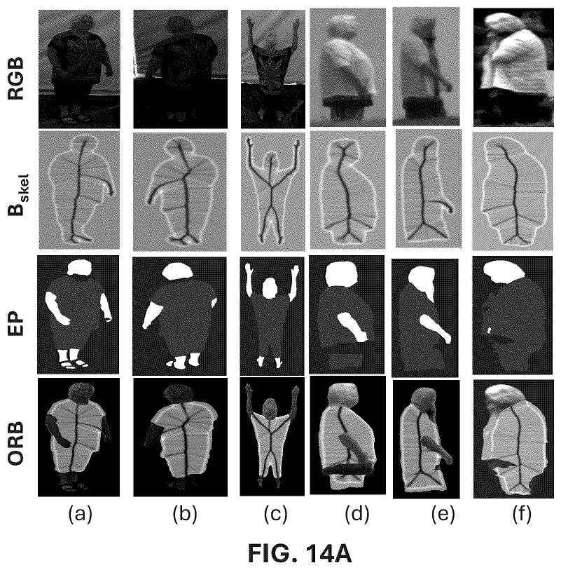

In some embodiments, two or more of a raw image, a biometric (auxiliary image), and an ORB image associated with an unknown human subject may be used to identify the unknown human subject. In some embodiments, individual images may be processed independently by different score generation pipelines and the resulting matching scores may be combined to generate a total score for identification. Alternatively, or in addition, in some embodiments, the feature embeddings extracted from the individual images, which are independently processed, may be fused to generate an aggregated feature embedding and used to generate the total score or a complementary score. FIG. 13 schematically illustrates an identification network 1300 comprising three score generation pipelines each comprising a feature extraction module comprising a recognition model (transformer), an optimization module comprising an optimization function, and an image matching module comprising a distance metric. In some cases, the identification network 1300 may be referred to as a TransFuse network indicating that the network is configured to generate scores and/or identity of a subject by fusing the outputs generated by different recognition models and/or different transformers at one or both score level and feature level. In some embodiment a first score generation pipeline may receive and process an RGB image 1220 of an unknown human subject to generate a first matching score, second score generation pipeline may receive and process a DIRB image 1224, e.g., derived from the RGB image 1220, to generate a second matching score, and a third score generation pipeline may receive and process an ORB image 1232, e.g., generated using the RGB image 1220 and DIRB image 1224, to generate a third matching score. In some cases, the first, second, and third matching scores may be combined to generate a total score for identifying the unknown human subject. In some implementations, the first feature extraction module of the first pipeline may comprise an appearance recognition model 1302, the second feature extraction module of the second pipeline may comprise an ORB recognition model 1308, and the third feature extraction module of the third pipe line may comprise a shape recognition model 1314.

In some embodiments, augmentation may be performed on the ORB image 1232, the RGB image 1220, or DIRB image 1224 (e.g., by an augmentation module similar augmentation module 108), and a model in a score generation pipeline may be trained on the resulting augmented image.

In some embodiments, the appearance, ORB, and shape recognition models 1302, 1308, 1314 may comprise substantially identical transformers. In some such embodiments, the transformers of the RGB (appearance), ORB, and DIRB (shape) recognition models 1302, 1308, 1314 may comprise same or different parameter values. In some embodiments, at least two of the appearance, ORB, and shape recognition models 1302, 1308, 1314 may comprise different transformers.

In some embodiments, a recognition model used by the first, second, and/or third recognition models 1302, 1308, 1314 may comprise a Swin transformer. The Swin transformer may comprise hierarchical structure and attention mechanisms adapted for modeling both local and global dependencies in an image (e.g., the ORB image 1232, the DIRB image 1224, or the RGB image 1220). Compared to more common CNNs, Swin transformers may comprise a better global contextual understanding provided by the self-attention mechanism. In some cases, the hierarchical approach of Swin may reduce computational cost while maintaining efficiency. Swin can include a sliding window algorithm that allows for a more flexible attention mechanism, e.g., compared to CNNs and some other transformers, and thereby enables modeling longer-range feature associations. In some of the results reported below (under section heading “Implementation and results), performance of Swin in ablation studies is compared with some other architectures to show its efficacy and superiority. In some embodiments, the first, second, and/or third recognition models 1302, 1308, 1314 may comprise separate Swin transformers configured to learn distinct and representation-specific patterns in the respective images (e.g., e.g., the ORB image 1232, the DIRB image 1224, or the RGB image 1220) thereby enhancing their ability to extract relevant features from the respective images for the recognition process. In some embodiments, such multi-pipeline (multi-branch) approach may allow the identification network 1300 to integrate complementary information from the different representations or modalities, leading to more robust and accurate recognition performance as indicated by some of the results reported below (under section heading “Implementation and results). In some cases, the recognition models used by the first, second, and/or third recognition models 1302, 1308, 1314 can be different and may comprise other architectures such as MGN.

In some implementations, first, second, third, optimization modules of the first, second, third, score generation pipelines may comprise first, second, third, optimization functions 1304, 1310, 1316. In some embodiments, the first, second, third, optimization functions 1304, 1310, 1316 can be substantially identical optimization functions. In some such embodiments, the first, second, third, optimization functions 1304, 1310, 1316 may comprise same or different parameter values. In some embodiments, at least two of the first, second, third, optimization functions 1304, 1310, 1316 can be different optimization functions.

In some implementations, first, second, third, image matching modules of the first, second, third, score generation pipelines may comprise first, second, third, score metrics 1306, 1312, 1318. In some embodiments, the first, second, third, score metrics 1306, 1312, 1318 can be substantially identical score metrics. In some such embodiments, the first, second, third, optimization functions 1304, 1310, 1316 may comprise a cosine distance between the corresponding feature embedding vectors. In some embodiments, at least two of the first, second, third, score metrics 1306, 1312, 1318 can be different metrics.

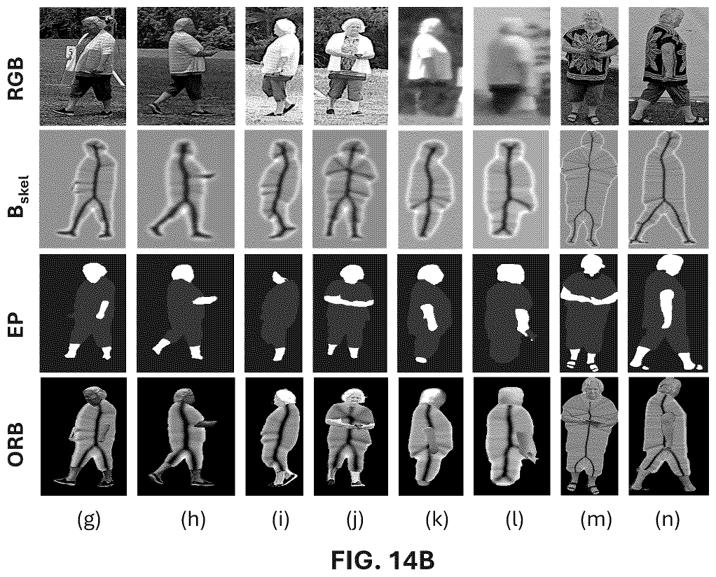

FIG. 14A-14B show fourteen example RGB images (top row) of a human subject captured under various distortive conditions and the corresponding Bₛₖₑₗ images (second row from top), enhanced parsed (EP) images (third row from top), and ORB images (bottom row). The RGB images are from the BRIAR dataset (the imaged human subject has authorized the use of these images). As shown, in these examples, shape biometric information (e.g., a skeleton-like biometric) is captured by the Bₛₖₑₗ, the body parts are isolated, using semantic knowledge, in the EP image and the noisy biometric information (e.g., regions covered with clothing) in the EP image, is replaced with the shape biometric information from the Bₛₖₑₗ to generate the ORB image. These examples depict the robustness of ORB across various challenging imaging conditions. For example, in FIG. 14A columns (a) to (c) comprise indoor images, with pose variations, articulation, and camera elevation. Columns (d) and (e) comprise similar poses, with and without articulation at 200 m imaging distance. Column (f) comprise extreme imaging condition for imaging range of 500 m. In FIG. 14B, columns (g) and (h) comprise close-range outdoor imaging, with walking, articulation, and occlusion. Columns (i) and (j) comprise pose variation, with lighting and turbulence challenges at a 100 m distance. Columns (k) and (l) comprise similar poses, with extreme imaging challenges such as turbulence and occlusion at varying imaging distances of 400 m and 200 m, respectively. Columns (m) and (n) comprise controlled indoor walking video frames used in the gallery.

As described above with respect to FIG. 13, in some implementations, these biometrics may be fused to perform aggregated recognition. As described above, in various implementations, fusion of the biometric information extracted from a raw image (e.g., RGB image) and different biometric image modalities (e.g., Bₛₖₑₗ and ORB images) may be performed at feature-level or score-level. Feature-level fusion may comprise fusing feature embeddings from each image (e.g., ORB, RGB, and Bₛₖₑₗ) before computing the matching score. Score-level fusion may comprise multiplying the individual scores from each modality, selecting the maximum score from the scores generated based on different images, or aggregating the scores in a different way.

### Implementation and Results

### Datasets Used

Some of the recognition models described above (e.g., those based on generation and processing an DIRB image) have been evaluated using three datasets: 1) OU-MVLP, 2) Gait3D and, 3) BRIAR. Table 1 includes certain features with respect to number of subjects, recognition task settings and challenges of each data set differentiating differences between the three datasets.

TABLE 1

| Dataset | Subjects | Gallery/Probe | Seq# | Challenges |
|---|---|---|---|---|
| OU-MVLP | 10,307 | Indoor/Indoor | 288,596 | Viewpoint |
| Gait3D | 4000 | Outdoor/Outdoor | 25,309 | Random Walk, |
| | | | | In-the-wild, |
| | | | | Viewpoint |
| BRIAR | 464 | Indoor/Outdoor | 54,895 | Long-Range, |
| | | | | Occlusion, |
| | | | | Atmospheric |
| | | | | Turbulence, |
| | | | | UAV, |
| | | | | Random Walk, |
| | | | | Clothing Change, |
| | | | | Carrying, |
| | | | | Viewpoint |

OU-MVLP comprises a large and commonly used Gait dataset. It consists of 10,307 subjects, each with two sequences (00 and 01), and 14 view angles (0°-90°, 180°-270°, at 15° intervals). The train and test division is done by official split. Due to the large size of the dataset, in the calculation below every 10th sample per view per subject during testing has been sampled, resulting in approximately 470K images in each of the gallery and probe image sets.

Gait3D comprises another large dataset collected in an outdoor setting, with a total of 4000 subjects. According to the official split, 3000 subjects are used for training and 1000 for testing in the calculations below. Results are reported on the split with one sequence as probe and the rest as gallery.

IARPA BRIAR dataset comprises a dataset containing data collected under unconstrained scenarios, as detailed in Table 1. BRIAR dataset is aimed towards tackling the challenges of human recognition under extreme imaging conditions.

The dataset further contains videos captured at distances varying from 100 m (indoor/outdoor) to 1000 m (outdoor). The recognition task is indoor gallery to outdoor probes, with clothes changed between gallery and probe. In some of the calculations below, 464 subjects from this dataset (BRS1, 1.1, 2, and 3 subsets) are used including 325 subjects used in training and the remaining 139 subjects for evaluation. In the test set, all indoor images with set 1 clothing are used for gallery and outdoor images with set 2 clothing are used for probe. The calculations include an ablation study on a subset of BRIAR data with 365 subjects, chosen from the two BRIAR subsets BRS2 and BRS3. To obtain grayscale images, RGB frames are processed to obtain Y component of YIQ color format.

The BRAIR dataset consists of controlled stills and controlled indoor videos for gallery, and unconstrained outdoor videos for probes. In order to achieve optimal performance with the least amount of training data, range-based sampling of the training data is performed. In some cases, all the gallery stills (108 images) and evenly sample 50 frames are used for controlled gallery videos. For the probe videos, this protocol is particularly effective, as the number of videos is unequal for shorter and longer ranges. Thus, in some cases, 150 frames per range per subject is used. For example, if a subject has 5 videos at the 1000 m distance, 30 frames per video for all 5 videos are evenly sampled. This can ensure appropriate diversity across all ranges for all subjects. BRS1-4 subsets included a total of 743 subjects resulting in approximately 1000-1400 images per subject.

### DIRB Results

Detection Results: Table 2 shows the Rank 1, 5, and 20 accuracies (in %) for the three datasets using Bskel images as inputs. In some cases, a Rank may indicate a position of the correct match in a sorted list of retrieved results based on similarity scores. Fo example, Rank 1 may comprise results having the highest similarity score (or lowest cosine/or other distance).

Results include the highest and lowest resolution Bₛₖₑₗ images (D0 and D8), as well as their score-level (SL) fusion results. Calculations leading to the selection of Di and SL fusion are provided in Tables 8 and 9. For score-level fusion, the mean values of the scores calculated for each image are used. The results obtained using Bₛᵢₗ and the corresponding Bₛₖₑₗ (DIRB) are compared to demonstrate the efficacy of the proposed Bₛₖₑₗ and indicating that SL fusion of Bₛₖₑₗ images can provide the superior Rank-20 performance of 94.87%, 78.19% and 85.17% for OU-MVLP, Gait3D and BRIAR datasets, respectively. Results in Table 2. include closed set detection results using an SSRNet (e.g., the identification system 100) for OU-MVLP (excluding identical-view cases), Gait3D and BRIAR datasets. Bₛₖₑₗ in Table 2 is a collective term for D0 and D8 (a DIRB image set including two DOG images), SL indicates score-level fusion (e.g., fusion of individual scores generated using D0 and D8) for each Rank 1, 5, 20. Top standalone (SL) input result is underlined, overall best result is presented as bold text. In table 2 and all tables below D\hat{ }0 (D hat 0) and D\hat{ }8 (D hat 8) are the first and last DoG images in a DoG pyramid comprising nine DOG images derived from a DTx image (similar to the examples shown in FIG. 7B).

TABLE 2

| Input | Dataset | R1 | R5 | R20 |
|---|---|---|---|---|
| Bₛᵢₗ | OU-MVLP | 73.82 | 87.56 | 91.22 |
| D0 | | 74.67 | 88.82 | 93.02 |
| D8 | | 74.22 | 88.11 | 93.06 |
| Bₛₖₑₗ (SL) | | 76.88 | 91.63 | 94.87 |
| Bₛᵢₗ | Gait3D | 36.18 | 57.76 | 74.74 |
| D0 | | 38.74 | 58.76 | 75.03 |
| D8 | | 38.49 | 58.45 | 75.52 |
| Bₛₖₑₗ (SL) | | 40.05 | 60.96 | 78.19 |
| Bₛᵢₗ | BRIAR | 24.15 | 54.78 | 82.62 |
| D0 | | 29.19 | 57.95 | 82.80 |
| D8 | | 28.55 | 58.13 | 83.05 |
| Bₛₖₑₗ (SL) | | 32.05 | 61.50 | 85.17 |

Testing robustness to limited availability of frames: the performance of the single-frame model based on DIRB image and the performance of existing gait recognition models, when a limited number of frames are available, are calculated and compared. For Gait3D dataset, performance is reported when limited frames are used in training and testing for three gait recognition algorithms, SMPLGait, GaitSet, and Gait-Part. The results are calculated for cases when either training or evaluation data include 10 frames each. A similar study is conducted for OU-MVLP dataset. Analysis has been performed using an existing model and GaitSet for 5 and 10 frames in training. These results are reported in Table 3. In some cases, the results are limited to Rank-1 accuracy for consistency with published results. For OU-MVLP dataset, the single-frame DIRB based model described above can have better or comparable performance compared to the existing methods. For more complex models, e.g., Gait3D datasets and/or single-frame DIRB based model can outperform most existing models by 5% or more (e.g., 7% and 33%), specifically when small number of frames are used for training and testing. Table 3 shows performance of Gait algorithms using limited number of frames, for Gait3D and OU-MVLP datasets vs SSRNet that uses only single frame. Results for comparative models are from for Gait3D and for OU-MVLP. Top results are Underlined, and best results are shown in bold font.

TABLE 3

| | | |
|---|---|---|
| Input | Model | Rank 1 |

Limited Frames: Gait3D Dataset

| | | |
|---|---|---|
| 10 frames | GaitPart | 19.10 |
| (Training) | GaitSet | 32.90 |
| | SMPLGait | 40.90 |
| 10 frames | GaitPart | 4.50 |
| (Testing) | GaitSet | 6.40 |
| | SMPLGait | 6.80 |
| Bₛₖₑₗ (SL) | SSRNet | 40.05 |

Limited Frames: OU-MVLP Dataset

| | | |
|---|---|---|
| 5 frames | GaitSet | 78.0 |
| (Training) | | 69.8 |
| 10 frames | GaitSet | 78.1 |
| (Training) | | 72.2 |
| Bₛₖₑₗ (SL) | SSRNet | 76.88 |

Robustness to imaging conditions: different models are tested when color videos include variations in clothing, environment (e.g., indoor and outdoor), and imaging distance. As an example, BRIAR dataset is used for these calculations. BRIAR dataset includes images allowing indoor (gallery) to outdoor (probe) matching, with clothing change between gallery and probe, with outdoor data collected at varying ranges. Grayscale images are used as the baseline input to further highlight the aforementioned complexities. BRIAR can include a combination of RGB and grayscale images, however for these calculations, the results of which are included in Table 4, all raw images are converted to grayscale before training SSRNet (e.g., the recognition model in feature embedding extraction module 110). The results indicate improved performance both when Bₛₖₑₗ images are used individually or fused with other image modalities. The results in Table 4 indicate score-level fusion of grayscale images with Bₛₖₑₗ features (e.g., using parallel pipeline similar to those shown in FIG. 8) provides a significant boost in performance. For example, Rank-1 result is improved from 17.30% for grayscale images to 40.34% for grayscale images fused with respective Bₛₖₑₗ images. These results show using Bₛₖₑₗ mages (DIRB images) not only improve the robustness of identification process in presence of images comprising clothing and environmental variations but also demonstrate that fusing Bₛₖₑₗ mages with grayscale image (e.g., at score level), can add complementary and identity-preserving features to the grayscale images and thereby augmenting the baseline performance of grayscale features. It is to be noted that grayscale image is an appearance-based biometric, whereas Bₛₖₑₗ and Bₛᵢₗ are shape-based biometrics. In some cases, the improved performance resulting from fusing either Bₛₖₑₗ or Bₛᵢₗ with grayscale may stem from combination the respective complementary modalities (i.e., shape-based and appearance-based biometrics). Results in Table 4 provides a comparison between system performance based on Bₛₖₑₗ and Grayscale images under changing clothes and environment (indoor gallery, set 1 clothing to outdoor probe, set 2 clothing) for 464 subjects (325 in train, 139 in test). SL indicates Score-level fusion.

TABLE 4

| Input | Rank1 | Rank5 | Rank20 |
|---|---|---|---|
| Bₛᵢₗ | 24.15 | 54.78 | 82.62 |
| RGB | 16.89 | 41.49 | 75.15 |
| Grayscale | 17.30 | 45.46 | 80.78 |
| \hat{D}₀ | 29.19 | 57.95 | 82.80 |
| \hat{D}₈ | 28.55 | 58.13 | 83.05 |
| Bₛₖₑₗ (SL) | 32.05 | 61.50 | 85.17 |
| Bₛₖₑₗ + Bₛᵢₗ (SL) | 33.71 | 63.11 | 86.78 |
| Bₛᵢₗ + Grayscale (SL) | 35.69 | 67.60 | 90.40 |
| Bₛₖₑₗ + Grayscale (SL) | 40.34 | 71.58 | 91.62 |
| All three (SL) | 42.03 | 72.45 | 91.44 |

Robustness to varying ranges: experiments are conducted on BRIAR dataset to assess the performance of our model across different imaging distances. The recognition model is trained using various ranges and the results are compared. The gallery (the reference images) is consistent for all ranges since it is indoor data, and the probe is split into various ranges (close-range, 100-300 m, and 300-600 m). The performance of the identification system 100 with DIRB image (as the biometric image 109) has been tested for different ranges and compared to overall performance. The results indicate that the performance is fairly consistent over different ranges (suggesting usability in real-world applications). The results for this study are shown in Table 5. Furthermore, upon comparison with grayscale data and binary silhouettes, we notice that our representation has better overall performance across all ranges. Table 5. shows results with varying ranges using SSRNet. The model is trained using all ranges and evaluated for varying ranges of probes. The training set includes 325 subjects, and the test set includes 139. The number of probe frames in close-range were 22,900, in 100-300 m were 33,470, and in 300-600 m were 20,575.

TABLE 5

| Input | Test Set | Rank1 | Rank5 | Rank20 |
|---|---|---|---|---|
| Bₛᵢₗ | All ranges | 24.15 | 54.78 | 82.62 |
| | Close-range | 26.58 | 56.74 | 84.21 |
| | 100-300 m | 25.11 | 56.28 | 83.35 |
| | 300-600 m | 22.18 | 52.71 | 81.83 |
| Grayscale | All ranges | 17.30 | 45.46 | 80.78 |
| | Close-range | 17.94 | 46.04 | 81.10 |
| | 100-300 m | 18.29 | 47.88 | 84.11 |
| | 300-600 m | 15.19 | 41.19 | 75.46 |
| Bₛₖₑₗ | All ranges | 32.05 | 61.50 | 85.17 |
| | Close-range | 34.76 | 63.92 | 86.05 |
| | 100-300 m | 32.61 | 62.15 | 85.78 |
| | 300-600 m | 28.84 | 58.75 | 84.91 |

Robustness to environment change: Table 4 shows the performance on the standard setup of BRIAR data, which includes indoor images as reference gallery and outdoor images as probe (making the identification task more complicated due to variation in both clothing and environment). To show that improved performance of the system when grayscale image is fused (at score-level) with Bₛₖₑₗ (that includes a pair of DIRB images in this case) or better performance of the system with Bₛₖₑₗ compared to other image modalities is not limited to difficult conditions (e.g., when variation in clothing and environment are combined), a test is performed to isolate variation in clothing and environment. A test is performed on a subset of BRIAR with 365 subjects, where indoor images (both set 1 and set 2) are used for gallery and outdoor images (both set 1 and 2) are used for probe. Thus, the gallery and probe both have samples from similar clothing, and the task is now isolated to recognition under varying environments (indoor to outdoor ranges). These results are reported in Table 6. Under consistent clothing conditions, the grayscale features may have a better performance. Nevertheless, the fusion of Bₛᵢₗ and Bₛₖₑₗ significantly bootstraps the performance of a baseline grayscale model, augmenting the Rank 1 accuracy by almost 15-16%. This demonstrates that fusing the proposed shape-based biometric (an DIRB image or a DIRB image set) with appearance features, e.g., at score-level, can improve the performance of the identification process when the environment varies but the clothing does not. Table 6 shows the impact of changing environment (indoor gallery to outdoor probes) with similar set clothing for grayscale images. Experiments are done on a subset of 365 subjects from BRIAR data, with 256 subjects in training and 109 subjects in evaluation.

TABLE 6

| Input | Rank1 | Rank5 | Rank20 |
|---|---|---|---|
| Bₛᵢₗ | 28.92 | 61.05 | 86.44 |
| Grayscale | 45.56 | 80.67 | 95.31 |
| \hat{D}₀ | 32.32 | 63.58 | 88.40 |
| \hat{D}₈ | 31.98 | 63.22 | 88.12 |
| Bₛₖₑₗ (SL) | 34.08 | 70.24 | 90.76 |
| Bₛᵢₗ + Grayscale (SL) | 56.14 | 85.23 | 95.88 |
| Bₛₖₑₗ + Grayscale (SL) | 58.31 | 87.56 | 96.19 |
| All three (SL) | 61.24 | 89.37 | 98.48 |

Robustness to clothing change: in another experiment environmental variations are eliminated to isolate and study the impact of clothing change. The results are obtained when gallery and probe images are indoor images, but the gallery and probe images comprise different clothing. The results are reported in Table 7. In this case, performance with Bₛₖₑₗ is similar to the performance with grayscale image, but when scores from Bₛₖₑₗ and grayscale images are fused, the performance is improved. The results indicate that score level fusing of the Bₛₖₑₗ and grayscale images improves the baseline grayscale performance, by nearly 20%. Table 7 shows the impact of changing clothes. Experiment done on a subset of 365 subjects from BRIAR, indoor-indoor matching, with changing clothes between gallery and probe. Train/test split: 256/109 subjects. SL: Score-level fusion.

TABLE 7

| Input | Rank1 | Rank5 | Rank20 |
|---|---|---|---|
| Bₛᵢₗ | 41.51 | 72.42 | 92.65 |
| Grayscale | 44.82 | 79.94 | 94.57 |
| \hat{D}₀ | 43.64 | 75.58 | 95.13 |
| \hat{D}₈ | 43.45 | 75.21 | 94.96 |
| Bₛₖₑₗ (SL) | 46.84 | 78.76 | 96.94 |
| Bₛᵢₗ + Grayscale (SL) | 58.17 | 86.32 | 97.14 |
| Bₛₖₑₗ + Grayscale (SL) | 59.46 | 86.87 | 97.67 |
| All three (SL) | 64.31 | 89.22 | 98.65 |

Choice of DoG pyramid image: experiments are performed using a DIRB image using different combinations DoG images D0, D4 and D8 (from the DoG pyramid shown in FIG. 7B. The results indicate that combining multiple DoG images can boost overall performance. Among DIRB image pairs including different combinations of D0, D4 and D8, the DIRB image set that includes D0 and D8 (DOG images with highest and lowest resolutions), provides better performance. While a DIRB image set that includes D0, D4 and D8, provides better performance than the DIRB image pairs, the improvement is not significant enough to warrant the additional computational cost associated with training HRNet based on a third image. As such, in some embodiments, score level fusion of D0 and D8 appears to be a suitable choice, providing a reasonable tradeoff between performance and computational cost. However, the embodiments are not limited to DIRB image pairs and DIRB image pairs are not limited to D0 and D8. In various applications, depending on distortive conditions, number of images available, and other factors, other combinations of DoG images and DIRB image sets comprising more images may provide between performance, e.g., when score level fusion is used to generate results based on multiple DOG images. Table 8 shows the results obtained using different combinations of DoG images and score level fusion (325 subjects are used in training, and 139 in evaluation).

TABLE 8

| Input | Rank1 | Rank5 | Rank20 |
|---|---|---|---|
| \hat{D}₀ | 29.19 | 57.95 | 82.80 |
| \hat{D}₄ | 27.84 | 57.09 | 82.45 |
| \hat{D}₈ | 28.55 | 58.13 | 83.05 |
| \hat{D}₀ + \hat{D}₄ (SL) | 31.47 | 61.07 | 84.95 |
| \hat{D}₀ + \hat{D}₈ (SL) | 32.05 | 61.50 | 85.17 |
| \hat{D}₄ + \hat{D}₈ (SL) | 31.07 | 60.95 | 84.82 |
| All three (SL) | 32.67 | 62.36 | 85.69 |

Image matching fusion techniques: as described above various techniques such as feature-level and score-level fusion can be used to identify a subject using multiple biometric images (e.g., multiple DoG images). In some cases, for feature-level fusion, the feature embeddings are combined right before the computation of matching score. For score-level fusion, several techniques including multiplication of scores, finding the max value among Bₛₖₑₗ image scores, and aggregation of the scores (obtained from different biometric images), are examined. Additionally, image-level fusion is tested where the grayscale, Bₛₖₑₗ and Bₛᵢₗ images are fused as a single biometric image provided to the feature embeddings extraction module for training HRNet. The results indicate that in some embodiments score-level fusion where the total score is the mean (or sum) of individual scores provides a better performance. Table 9 shows results of different fusion techniques. Experiments were conducted using 464 Briar subjects (325 in training, and 139 in evaluation).

TABLE 9

| Fusion Method | Rank1 | Rank5 | Rank20 |
|---|---|---|---|
| Input-level | 14.07 | 32.42 | 63.93 |
| Feature-level | 36.65 | 67.94 | 89.68 |
| Score-level (prod) | 36.77 | 69.06 | 85.90 |
| Score-level (max) | 24.20 | 56.59 | 86.50 |
| Score-level (sum) | 40.06 | 71.35 | 91.39 |

Resource Utilization: one of the benefits of SSRNet and the proposed single-frame inputs is that the embedding size is very small, allowing for faster computations. In the proposed configuration of SSRNet, the embedding size is 512, and each gallery and probe embedding utilizes a size of less than 2 KB. When trained on Tesla GPU, the speed to compute embeddings is over 50 frames/sec and that for image matching is greater than 2500 probes/sec. The computation of Bₛₖₑₗ from Bₛᵢₗ is 12-15 images/sec using CPU.

Training and Computation Details: to obtain the silhouette from RGB video for the Briar dataset, we use YOLOv5 to perform human detection to extract the bounding box. Then, CropFormer may be used to extract the silhouette. The BRIAR dataset consists of over 3.2 million images. To ensure a trade-off between speed and accuracy YOLOv5 is used however embodiments are not so limited and other algorithms (e.g., YOLOv8) can be used. To compute the distance transform, 5×5 mask was used with L2 as distance metric. To compute the DoG images, the process starts with a Gaussian kernel having a=1.2 for the first (of the 3) scales, scaling it by a factor of ½′ for each of the remaining scales (where n is positive integer). The input to HRNet can have a size of 224×224. To preserve the aspect ratio of the shape of the subjects in the tight bounding boxes, resizing is performed with padding instead of regular resizing. For each DoG image of the DoG pyramid (Di), a separate HRNet is trained. Thus, when fusing D0 and D8, two HRNets are used. Training two models for two biometric images can be advantageous because: (a) it makes the method more modular, since any feature can be applied in a “plug-and-play” fashion as and when needed in gait or RGB tasks without additional dependencies, and (b) it appears that score-level fusion can provide better results. In some cases, each dataset is trained using its own training data, as the recognition task for each dataset can be different. A 30-layer HRNet is used as the recognition model and was trained for 120 epochs, picking the model with the lowest loss. Adam optimizer, with a learning rate of 0.001, and cosine LR scheduler was used (e.g., learning rate of 0.001, and cosine LR scheduler can be hyper parameters used for training of HRNet). For augmentations, random erasing (with a probability of 0.4), horizontal flipping (with a probability of 0.5), shear, translation, perspective transforms (with probability of 0.2 each), and random erosion and dilation (with probability 0.25) are used. The batch size can be 40 and embedding size can be 512.

### ORB Results

### Additional Datasets Used: For Testing of ORB Representation

PRRCC: PRCC is a commonly used dataset for subject re-identification (Re-ID) based on images comprising different clothing. The PRCC dataset comprises 33,698 images of 221 distinct identities. The dataset is structured to test Re-ID systems under realistic conditions where clothing changes occur. Specifically, images from cameras A and B featuring the same individuals in identical clothing but captured in different rooms, while Camera C presents the same individuals in different outfits on different days.

Celeb-ReID: This dataset consists of street snapshots of celebrities from the internet. It consists of 34,186 images with 1,052 subjects. In addition to clothing change, this dataset also suffers from imaging distortions and pose variations.

VC-Clothes: This data is a synthetic clothes-changing dataset generated using GTA5 game. It features 512 identities captured across 4 scenes/cameras, with each identity having an average of nine images per scene, totaling 19,060 images. The dataset is split evenly between 256 identities for training and 256 for testing, with about 1-3 outfit changes per subject.

### Experimental Setups

TransFuse results with benchmark datasets: Table 10 shows the results of the disclosed TransFuse method/model for changing clothes and general setups of the PRCC dataset, compared with some of existing models. Table 10 includes results of the TransFuse method using the Swin and MGN models/backbones. Bold font represents the best overall result, and Underlined represents the second-best result. Results are reported for general (including similar clothing), and clothing change setups. Results are divided based on RGB-only models (listed in chronological order) in rows 1-4; followed by multi-modal models (listed in chronological order) in rows 5-14. The results indicate that the TransFuse method (i.e., identifying a subject using RGB, DIRB, and ORB images and the identification network 1300 described above with respect to FIG. 13) can achieve results comparable to some of the best existing models and methods. In some cases, changing the backbone (e.g., the recognition model) from Swin to MGN improves the results. These results further demonstrate that identification based on ORB images can be compatible with most existing recognition backbones (e.g., RGB based systems).

TABLE 10

| | | | PRCC Dataset | | | |
|---|---|---|---|---|---|---|
| | | | Clothing Change | | General | |
| Methods | Modalities | Reference | Rank-1 | mAP | Rank-1 | mAP |
| PCB | RGB | ECCV 2018 | 41.8 | 38.7 | 99.8 | 97.0 |
| RGA-SC | RGB | CVPR 2020 | 42.3 | — | 98.4 | — |
| RCSANet | RGB | ICCV 2021 | 48.6 | 50.2 | 100 | 97.2 |
| MCSC-CAL | RGB | TIP 2024 | 57.8 | 57.3 | 99.8 | 99.8 |
| CESD | RGB + Pose | ACCV 2020 | — | — | — | — |
| FSAM | RGB + | CVPR 2021 | 54.5 | — | 98.8 | — |
| | Pose + Sil | | | | | |
| 3DSL | RGB + | CVPR 2021 | 51.3 | — | — | — |
| | 3D pose + Sil | | | | | |
| CAL | RGB + | CVPR 2022 | 55.2 | 55.8 | 100 | 99.8 |
| | Clothes ID | | | | | |
| AIM | RGB + | CVPR 2023 | 57.9 | 58.3 | 100 | 99.9 |
| | Clothes ID | | | | | |
| CCFA | RGB + | CVPR 2023 | 61.2 | 58.4 | 99.6 | 98.7 |
| | Clothes ID | | | | | |
| DCR-ReID | RGB + Sil + | TCSVT 2023 | 57.2 | 57.4 | 100 | 99.7 |
| | Clothes ID | | | | | |
| SC-Net | RGB + Sil | ACM MM 2023 | 61.3 | 59.9 | 100 | 97.8 |
| CVSL | RGB + Pose | WACV 2024 | 57.5 | 56.9 | 97.5 | 99.1 |
| TransFuse | ORB + | | 58.6 | 55.7 | 100 | 99.6 |
| (using Swin) | Bₛₖₑₗ + RGB | | | | | |
| TrasFuse | ORB + | | 62.0 | 58.3 | 100 | 99.8 |
| (using MGN) | Bₛₖₑₗ + RGB | | | | | |

Table 11 shows the results using TransFuse for the same using the VC-Clothes and Celeb-ReID datasets. For VC-Clothes, these results are obtained using the recognition methods described above (e.g., based on biometric image 109 or composite biometric image 1112). across all cameras, the same clothing setup (between cameras 2 and 3), and changing clothes setup (between cameras 3 and 4). The results show that for both VC-Clothes and Celeb-ReID, TransFuse method can generate results comparable to some of best existing methods. We note that compared to other datasets, ORB images can provide good standalone performance, and TransFuse method, which includes RGB, ORB, and DIRB, can provide results similar or, in some cases, better than to some of best existing methods. Table 11 includes a comparative analysis of the performance of some of the best existing models/methods and TransFuse method based on VC-Clothes and Celeb-ReID datasets. The TransFuse results are obtained using Swin backbone. Text with bold font represents the best overall result, and underlined text represents the second-best results. Results are reported for general, similar clothing, and clothing change setups for VC-Clothes, and standard clothing change setup for Celeb-ReID. Results are divided based on RGB-only models (listed in chronological order) in rows 1-5; followed by multimodal models (listed in chronological order) in rows 6-7.

TABLE 11

| | | | VC-Clothes | | | | | | | |
|---|---|---|---|---|---|---|---|---|---|---|
| | | | General | | SC | | CC | | Celeb-ReID | |
| | | | (All cams) | | (Cams 2&3) | | (Cams 3 and 4) | | General CC | |
| Methods | Modalities | Publication | Rank-1 | mAP | Rank-1 | mAP | Rank-1 | mAP | Rank-1 | mAP |
| HACNN | RGB | CVPR 2018 | 68.6 | 69.7 | — | — | 49.6 | 50.1 | 47.6 | 9.5 |
| PCB | RGB | ECCV 2018 | 87.7 | 74.6 | 94.7 | 94.3 | 62.0 | 62.2 | 37.1 | 8.2 |
| TransReid | RGB | ICCV 2021 | 90.5 | 80.1 | 95.1 | 94.5 | 70.0 | 71.8 | 58.9 | 14.6 |
| FSAM | RGB + Pose + Sil | CVPR 2021 | — | — | 94.7 | 94.8 | 78.6 | 78.9 | — | — |
| CAL | RGB + Clothes ID | CVPR 2022 | 92.9 | 87.2 | 95.1 | 95.3 | 81.4 | 81.7 | — | — |
| TransFuse | ORB + Bₛₖₑₗ + RGB | | 92.7 | 84.2 | 96.07 | 94.37 | 88.23 | 85.79 | 56.42 | 12.18 |
| (using Swin | | | | | | | | | | |
| transformer) | | | | | | | | | | |

Table 12, includes a more in-depth analysis showing a comparison between the performances based on ORB, RGB, and DIRB (Bₛₖₑₗ) image modalities and using the Swin model/backbone. Performance of each standalone modality and its various fusion metrics is reported. The results show RGB has strong performance for the same clothing used but ORB can outperform RGB modality when the clothing changes. This shows that a fixed clothing setting, RGB can provide color matching on clothing (a feature typically unavailable for cloth-changing settings) thus leaving just the biometric features to be analyzed. In such cases, the proposed ORB can have a much better performance, outperforming RGB. Results in Table 12 include performance of individual image modalities and their fusion across several public datasets using TranFuse models with a Swin model/backbone. Bold font represents the key performance trend to observe, whereas Italics font represent the overall TransFuse results.

TABLE 12

| | PRCC SC | | PRCC CC | | VC-Clothes SC | | VC-Clothes CC | |
|---|---|---|---|---|---|---|---|---|
| Modalities | Rank-1 | mAP | Rank-1 | mAP | Rank-1 | mAP | Rank-1 | mAP |
| RGB | 99.95 | 99.43 | 43.3 | 44.7 | 96.47 | 94.88 | 72.94 | 74.06 |
| Bₛₖₑₗ | 56.41 | 29.87 | 28.3 | 17.4 | 40.78 | 23.69 | 47.84 | 26.39 |
| ORB | 86.45 | 75.30 | 52.0 | 44.8 | 94.90 | 91.48 | 83.14 | 79.49 |
| All three | 100 | 99.6 | 58.6 | 55.7 | 96.07 | 94.37 | 88.23 | 85.79 |

TransFuse results with BRIAR dataset: The BRIAR dataset has been evaluated in two setups: 1) a first setup uses the two latest released subsets of the BRIAR training data (BRS 3 and 4). This consists of 363 subjects, with 273 subjects in training and 90 in testing. Results have been obtained using several image modalities (ORB, DIRB, Bₛₖₑₗ), and RGB), and the robustness of the proposed method with respect to changing clothes, changing environment, and across varying imaging ranges, has been evaluated. 2) a second setup uses the standard BRIAR task, with training performed using all 5 released BRIAR training subsets (BRS 1, 1.1, 2, 3, and 4), and evaluation done on Phase 1 and Phase 2 evaluation protocols by ORNL (EP3.1 and EP4.2, respectively). For both protocols, the studies are focused on the Face-Restricted Treatment (FRT) subsets. The FRT subsets of any BRIAR evaluation protocol are defined by probes where less than 1% of the face is visible in each frame of a video, thereby severely limiting the dependency on purely appearance-based biometric matching. For EP3.1, the test set consists of data from 4 BRIAR testing subsets (BTS1, 1.1, 2, and 3), whereas EP4.2 also additionally contains data from BTS4. For the FRT subset, verification is the most important metric, with Phase 1 focusing on TAR@1% FAR and Phase 2 focusing on TAR @0.1% FAR.

Table 13 reports the results of the first evaluation setup of BRIAR across various imaging modalities and their subsequent fusion. We note that ORB significantly outperforms RGB modality. We also note that unlike public datasets, the fusion of all three modalities performs the best for BRIAR (instead of only ORB and RGB), due to the extremely challenging nature of the data, where Bₛₖₑₗ learns crucial complementary information. In fact, a key observation here is that the fusion of RGB and Bₛₖₑₗ gives the biggest boost from their respective individual modalities than any other pair-wise fusion. This is because appearance and shape features are inherently completely complimentary, unlike ORB which has information from both. Table 13 shows performance of individual modalities and their fusion on the most recent BRIAR subsets (BRS 3 and 4). This consists of 363 subjects, with 273 subjects in training and 90 in testing. Bold font represents the best overall performance, and underline represents best standalone modality. SL: Score-level Fusion. Matching is done on the standard BRIAR task, with set 1 clothing indoor data as gallery and set 2 clothing outdoor data as probe.

TABLE 13

| Input | Rank1 | Rank5 | Rank20 |
|---|---|---|---|
| \hat{D}₀ | 18.97 | 44.44 | 77.45 |
| \hat{D}₈ | 19.17 | 44.84 | 78.28 |
| RGB | 26.61 | 58.27 | 85.39 |
| ORB | 44.19 | 77.13 | 94.06 |
| Bₛₖₑₗ (SL) | 19.72 | 45.57 | 79.03 |
| Bₛₖₑₗ + RGB (SL) | 32.80 | 64.58 | 91.20 |
| RGB + ORB (SL) | 44.24 | 76.18 | 95.22 |
| Bₛₖₑₗ + ORB (SL) | 39.52 | 71.50 | 93.57 |
| All three (SL) | 44.81 | 76.85 | 95.90 |

Table 14 contains the results of TransFuse for the closed-set detection and verification tasks under EP3.1 and 4.2 protocols. Table 14 shows BRIAR evaluation protocol results for EP3.1 and EP4.2. The metrics of interest are closed-set Rank-20 performance, and verification performances—TAR @1% for EP3.1, and TAR @0.1% FAR for EP4.2. The target metric for the Face Restricted Treatment (FRT) subset for verification is provided in (bold font in the parenthesis).

TABLE 14

| Input | Rank-20 | TAR@1% FAR | TAR@0.1% FAR |
|---|---|---|---|
| EP3.1 | 76.5 | 53.5 (50) | 19.7 |
| EP4.2 | 77.7 | 55.2 | 24.0 (50) |

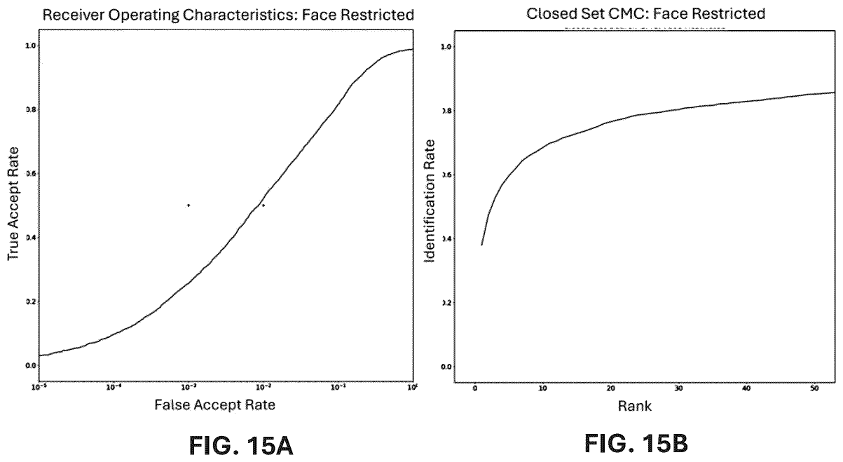

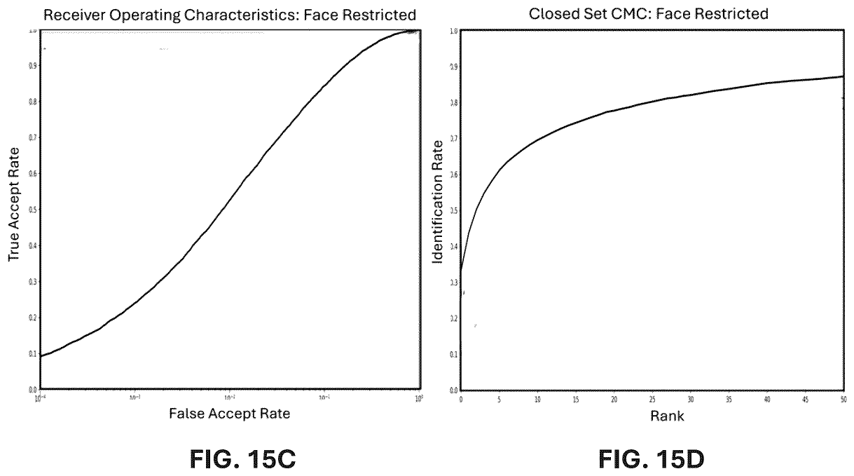

FIG. 15A-15B show calculated true accept rate plotted against false accept rate for EP3.1 verification performance (A) and calculated identification rate plotted against rank for EP3.1 closed set performance. FIG. 15C-15D show calculated true accept rate plotted against false accept rate for EP4.2 verification performance (A) and calculated identification rate plotted against rank for EP4.2 closed set performance. EP3.1 consists of 8136 probes, whereas EP4.2 contains 7642 probes. For both evaluation setups, the gallery is indoor data with Set 1 clothing, and the probe is outdoor data with Set 2 clothing, the standard BRIAR setup.

Robustness to Clothing Change: in this study certain subsets of BRIAR are used to isolate the impact of clothing change artifacts. Clothing change is isolated by performing an indoor-to-indoor matching, across both sets of clothing. Images in set 1 including clothing are used as the gallery and images in set 2 as the probe. Since the indoor images of BRIAR data are captured under similar conditions for both clothing, this removes any other variables in the imaging such as imaging distortions. The results for this experiment are given in Table 15. Table 15 shows the impact of changing clothes on the recognition task. Experiment done on a subset of 363 subjects from BRIAR, indoor-indoor matching, with changing clothes between gallery and probe. 273 were used for training and 90 subjects for the test. SL indicates score-level fusion, bold text represents the best overall performance, and underline represents the best standalone modality. These results indicate that ORB can outperform RGB in this setup, establishing ORB's efficacy in clothing change recognition. Further results indicate that fusing other image modalities with ORB can provide a noticeable improvement with respect to combinations that do not include ORG image.

TABLE 15

| Input | Rank1 | Rank5 | Rank20 |
|---|---|---|---|
| \hat{D}₀ | 38.09 | 65.40 | 88.56 |
| \hat{D}₈ | 38.87 | 66.86 | 89.33 |
| RGB | 47.91 | 70.37 | 91.59 |
| ORB | 68.64 | 87.67 | 94.99 |
| Bₛₖₑₗ (SL) | 39.79 | 66.90 | 89.38 |
| Bₛₖₑₗ + RGB (SL) | 58.32 | 81.68 | 93.99 |
| ORB + Bₛₖₑₗ (SL) | 66.71 | 85.42 | 94.64 |
| ORB + RGB (SL) | 68.28 | 86.64 | 96.06 |
| ORB + RGB + Bₛₖₑₗ (SL) | 71.31 | 87.95 | 95.49 |

Robustness to Environment Change: In this study environment change aspect of the BRIAR data is isolated, to evaluate the efficacy of the proposed ORB under indoor-to-outdoor matching task. Indoor data with clothing in set 1 are used as the gallery and outdoor data with clothing in set 1 are used as the probe. The results are reported in Table 16. The results indicate that ORB and RGB provide substantive the same performance. This can be due to the fact when subject's face is not visible, but the clothing does not change, RGB can still match pixels on the clothing to find a match. Note that this is not a robust method for matching, as it can be seen that under unconstrained conditions (Table 13), ORB has a distinct advantage.

Table 16 shows the impact of a changing environment (indoor gallery to outdoor probes) with similar clothing for RGB images. Experiments are done on a subset of 363 subjects from BRIAR data, with 273 subjects in training and 90 subjects in evaluation. Bold text represents the best overall performance, and Underline represents the best standalone modality.

TABLE 16

| Input | Rank1 | Rank5 | Rank20 |
|---|---|---|---|
| \hat{D}₀ | 36.51 | 63.10 | 85.48 |
| \hat{D}₈ | 36.84 | 63.09 | 85.25 |
| RGB | 90.46 | 97.61 | 99.45 |
| ORB | 67.49 | 86.22 | 95.97 |
| Bₛₖₑₗ (SL) | 37.87 | 64.31 | 86.12 |
| Bₛₖₑₗ + RGB (SL) | 87.25 | 96.48 | 99.21 |
| ORB + Bₛₖₑₗ (SL) | 65.69 | 84.53 | 95.28 |
| ORB + RGB (SL) | 58.31 | 87.56 | 96.19 |
| ORB + RGB + Bₛₖₑₗ | 89.25 | 97.00 | 99.45 |

Robustness to Imaging Distance: To evaluate the robustness of the proposed representation across varying imaging ranges, in this study probe images are divided into several ranges including less than 100 m (close-range), 100-300 m, and 300-600 m, and over 600 m (UAV/long-range). The same gallery (indoor, set 1 clothing) has been used to evaluate performance on these various probes. The results are reported in Table 17. The results indicate that ORB images can outperform other image modalities. This is a significant characteristic of ORB that makes it highly effective and robust biometric. Results in Table 17 include results obtained with varying ranges using different modalities that may be fused, e.g., at score level. The model is trained on all ranges and evaluated for varying ranges of probes. The number of probe frames in close-range were 5663, in the 100-300 m range were 11,732, in 300-600 m range were 10,727, and in the long-range (UAV range) were 6015. Bold text represents the best performance.

TABLE 17

| Input | Test Set | Rank1 | Rank5 | Rank20 |
|---|---|---|---|---|
| RGB | Close-range | 29.50 | 64.93 | 89.01 |
| | 100-300 m | 29.82 | 62.95 | 87.20 |
| | 300-600 m | 22.79 | 51.15 | 82.77 |
| | UAV/Long-range | 24.44 | 55.54 | 82.94 |
| Bₛₖₑₗ | Close-range | 31.52 | 57.02 | 82.78 |
| | 100-300 m | 25.23 | 53.82 | 83.45 |
| | 300-600 m | 9.52 | 32.18 | 72.88 |
| | UAV/Long-range | 16.01 | 42.43 | 77.87 |
| ORB | Close-range | 51.37 | 83.19 | 96.02 |
| | 100-300 m | 49.78 | 80.95 | 96.26 |
| | 300-600 m | 34.05 | 69.20 | 91.45 |
| | UAV/Long-range | 44.47 | 77.82 | 92.17 |

### Ablation Studies

Varying Recognition Backbone: In this section, the efficacy of using the Swin transformer as recognition model/backbone is tested. For a fair comparison, the performances are calculated on various backbones using RGB but not ORB. Comparisons are made using ResNet50, HRNet30, and Swin. The results are shown in Table 18. Experiments were conducted on RGB modality, using 363 Briar subjects (273 in training, and 90 in evaluation). Bold text represents the best performance.

TABLE 18

| Backbone | Rank1 | Rank5 | Rank20 |
|---|---|---|---|
| ResNet50 | 25.67 | 57.83 | 84.83 |
| HRNet-30 | 25.01 | 51.53 | 85.35 |
| Swin Transformer | 26.61 | 58.27 | 85.39 |

### Training and Inference Details

Resource Utilization: The speed of computing Bₛₖₑₗ on a CPU is about 12-15 images/sec. When using a NVIDIA GeForce RTX 3080 GPU, the overall time to process a single RGB frame to obtain ORB representation is <0.5 s. One of the benefits of our proposed approach and the proposed unified biometric (ORB) is that the embedding size is very small that allows for faster computations. The overall speed of template matching and template size are important criteria in the BRIAR evaluation protocol. In the proposed configuration of TransFuse, the embedding size is 1024 per modality (approx. 4 KB), and each gallery and probe embedding utilizes a size of about 12 KB. The BRIAR requirement for a max template size is <1 MB, which can be greater than the embedding size used here. When computing on NVIDIA GeForce RTX 3080 GPU, the speed to compute embeddings per modality is <0.02 s and that for image matching is greater than 2500 probes/sec.

Training and Computation Details: To extract silhouettes from RGB videos of the BRIAR dataset YOLOv5 is used for human detection to identify bounding boxes and CropFormer to obtain the silhouettes or inverse silhouettes. For computing the distance transform, a 5×5 mask with the L2 distance metric is applied. To generate the Difference of Gaussians (DoG) images, a Gaussian kernel with 6=1 for the first of three scales, scaling it by a factor of ½″ for the subsequent scales. The input size for the Swin Transformer is 224×224, while for the MGN backbone, it is 128×384.

To maintain the aspect ratio of subjects within tight bounding boxes, resizing is used with padding (e.g., instead of standard resizing). A separate recognition backbone is trained for each input image modality. For example, when fusing RGB and ORB, two networks are used. Separate models are trained for each modality because: (1) Modularity: This approach allows for any feature to be applied in a “plug-and-play” fashion as needed without additional dependencies, and (2) Performance: Experimental results indicate that among early input-level fusion, late-stage feature fusion, and score-level fusion, in some cases, score-level fusion can yield better results. Each dataset is trained using its own training data, given the different recognition tasks. In some cases, the base Swin model was used in the recognition model, and it was trained for 120 epochs and, in some cases, the model with the lowest loss is selected. In some cases, the training process uses the Adam optimizer, a learning rate of 0.001, and a cosine learning rate scheduler. For data augmentations, in some cases, random erasing with a 0.4 probability, horizontal flipping with a 0.5 probability, and shear, translation, and perspective transforms with a 0.2 probability each, are used. Random erosion and dilation may be applied with a 0.25 probability. A batch size of 24 and an embedding size of 1024 was used. The MGN model is trained for 1000 epochs, with a MultiStepLR scheduler with steps at 300 and 600. The initial learning rate was set to 5e-4 with a batch size of 4 per ID. For score-level fusion, equal weights were assigned to each score, e.g., when calculated the mean value. However, the embodiments are not so limited and in various implementations different weighs may be assigned to individual scores when an aggregate (or total) score is calculated for score level fusion. Table 19 shows results of comparing different fusion technique indicating that for the selected data sets and within the limitation of the experiment can provide between performance (as indicated earlier). Experiments were conducted on the fusion of ORB, RGB, and Bₛₖₑₗ, using 363 Briar subjects (273 in training, and 90 in evaluation). Bold text represents the best performance among the presented methods.

TABLE 19

| Fusion Method | Rank1 | Rank5 | Rank20 |
|---|---|---|---|
| Feature-level | 44.42 | 73.88 | 93.72 |
| Score-level (prod) | 39.94 | 66.81 | 82.40 |
| Score-level (max) | 39.28 | 73.22 | 94.80 |
| Score-level (sum) | 44.81 | 76.85 | 95.90 |

### Additional Example Embodiments

Various additional example embodiments of the disclosure can be described by the following examples:

### Group I

Clause 1. A computer-implemented method of determining identity of a subject using a shape-capturing image comprising the subject, the computer-implemented method comprising: by an electronic processor, which is configured to execute specific computer-executable instructions stored in a non-transitory memory: receiving the shape-capturing image; generating a distance transformed image using the shape-capturing image; generating a multi-scale representation of the distance transformed image, extracting a first feature embedding from the multi-scale representation using a recognition model, the first feature embedding comprising a first numerical representation of a feature in the multi-scale representation; and determining the identity of the subject using at least the first feature embedding and a first reference feature embedding.

Clause 2. The computer-implemented method of clause 1, wherein the shape-capturing image comprises an inverse silhouette image or a silhouette image.

Clause 3. The computer-implemented method of clause 1, further comprising generating the shape-capturing image using a raw image of the subject.

Clause 4. The computer-implemented method of clause 3, wherein the raw image comprises an RGB image or a grayscale image.

Clause 5. The computer-implemented method of clause 3, wherein generating the distance transformed image comprises: extracting an inverse silhouette image from the raw image; and determining the distance transformed image using the inverse silhouette image.

Clause 6. The computer-implemented method of clause 1, wherein the multi-scale representation comprises a first biometric image comprising a biometric feature of the subject.

Clause 7. The computer-implemented method of clause 6, wherein the first biometric image comprises a skeleton-like pattern associated with the subject.

Clause 8. The computer-implemented method of clause 6, wherein the biometric feature is not distinguishable in the shape-capturing image.

Clause 9. The computer-implemented method of clause 6, wherein the first biometric image comprises a Difference of Gaussian (DoG) image and generating the multi-scale representation of the distance transformed image comprises blurring the distance transformed image using a Gaussian kernel.

Clause 10. The computer-implemented method of clause 1, wherein generating the multi-scale representation of the distance transformed image comprises generating a Difference of Gaussian (DoG) pyramid and selecting a first DoG image from the DoG pyramid.

Clause 11. The computer-implemented method of clause 10, wherein generating the multi-scale representation of the distance transformed image further comprises selecting a second DoG image from the DoG pyramid.

Clause 12. The computer-implemented method of clause 11, further comprising extracting the first feature embedding from the first DoG image and extracting a second feature embedding from the second DoG image and determining the identity of the subject further using the second feature embedding.

Clause 13. The computer-implemented method of clause 6, further comprising, receiving or generating a second biometric image.

Clause 14. The computer-implemented method of clause 13, further comprising extracting a second feature embedding from the second biometric image and determining the identity of the subject using the second feature embedding.

Clause 15. The computer-implemented method of clause 14, wherein the second biometric image comprises an RGB image or a Grayscale image.

Clause 16. The computer-implemented method of clause 1, wherein determining the identity of the subject comprises: generating the first reference feature embedding using a reference raw image or a reference shape-capturing image; determining a cosine distance of the first reference feature embedding with respect to the first feature embedding; and determining a cosine distance of the first reference feature embedding with respect to the first feature embedding.

Clause 17. The computer-implemented method of clause 1, wherein extracting the first feature embedding comprises training the recognition model by performing a multi-scale feature concatenation to hierarchically fuse high resolution and low-resolution features.

Clause 18. The computer-implemented method of clause 1, wherein the recognition model comprises a multilayer high-resolution network (HR-NET).

Clause 19. The computer-implemented method of clause 1, wherein extracting the first feature embedding comprises generating a primary feature embedding using the recognition model and optimizing the primary feature embedding to generate the first feature embedding.

Clause 20. The computer-implemented method of clause 19, wherein optimizing the primary feature embedding comprises performing a multi-objective optimization using a loss function.

Clause 21. The computer-implemented method of clause 20, wherein the loss function comprises one or more of an absolute loss, a contrastive loss, and an angular loss.

Clause 22. The computer-implemented method of clause 20, wherein the loss function comprises at least an angular loss.

Clause 23. The computer-implemented method of clause 1, wherein the feature comprises a skeleton-like pattern associated with the subject.

Clause 24. The computer-implemented method of clause 1, wherein the first reference feature embedding comprises a second numerical representation of a reference feature extracted from a reference raw image.

Clause 25. The computer-implemented method of clause 24, wherein the first numerical representation and the second numerical representation comprise first and second vectors and determining the identity of the subject comprise determining a cosine distance between the first and second vectors.

Clause 26. The computer-implemented method of clause 1, wherein determining the identity of the subject comprises: generating the first reference feature embedding using a reference raw image or a reference shape-capturing image; and determining a cosine distance of the first reference feature embedding with respect to the first feature embedding.

Clause 27. The computer-implemented method of clause 26, wherein generating the first reference feature embedding comprises generating a plurality of reference feature embeddings using a plurality of reference raw images and aggregating the plurality of reference feature embeddings to obtain an aggerate reference feature embedding, and wherein the first reference feature embedding comprises the aggerate reference feature embedding.

### Group II

Clause 1. A biometric system for determining identity of a subject using a shape-capturing image, the biometric system comprising: a data interface configured to receive the shape-capturing image; a non-transitory memory configured to store specific computer-executable instructions; and an electronic processor in communication with the non-transitory memory and configured to execute the specific computer-executable instructions to at least: generate a distance transformed image using the shape-capturing image; generate a multi-scale representation of the distance transform image, extract a first feature embedding of the multi-scale representation using a recognition model, first feature embedding comprising a first numerical representation of a feature in the multi-scale representation; and; and determine the identity of the subject using at least the first feature embedding and a first reference feature embedding.

Clause 2. The biometric system of clause 1, wherein the shape-capturing image comprises an inverse silhouette image or a silhouette image.

Clause 3. The biometric system of clause 1, wherein the electronic processor is further configured to execute the specific computer-executable instructions to generate the shape-capturing image using a raw image of the subject.

Clause 4. The biometric system of clause 3, wherein the raw image comprises an RGB image or a grayscale image.

Clause 5. The biometric system of clause 3, wherein the electronic processor is further configured to execute the specific computer-executable instructions to generate the distance transformed image by: extracting an inverse silhouette image from the raw image; and determining the distance transformed image using the inverse silhouette image.

Clause 6. The biometric system of clause 1, wherein the multi-scale representation comprises a first biometric image comprising a biometric feature of the subject.

Clause 7. The biometric system of clause 6, wherein the first biometric image comprises a skeleton-like pattern associated with the subject.

Clause 8. The biometric system of clause 6, wherein the biometric feature is not distinguishable in the shape-capturing image.

Clause 9. The biometric system of clause 6, wherein the first biometric image comprises a Difference of Gaussian (DoG) image and generating the multi-scale representation of the distance transformed image comprises blurring the distance transformed image using a Gaussian kernel.

Clause 10. The biometric system of clause 1, wherein the electronic processor is further configured to execute the specific computer-executable instructions to generate the multi-scale representation of the distance transformed image by generating a Difference of Gaussian (DoG) pyramid and selecting a first DoG image from the DoG pyramid.

Clause 11. The biometric system of clause 10, wherein the electronic processor is further configured to execute the specific computer-executable instructions to generate the multi-scale representation of the distance transformed image by selecting a second DoG image from the DoG pyramid.

Clause 12. The biometric system of clause 11, wherein the electronic processor is further configured to execute the specific computer-executable instructions to extract the first feature embedding from the first DoG image and a second feature embedding from the second DoG image and determine the identity of the subject using the second feature embedding.

Clause 13. The biometric system of clause 6, wherein the electronic processor is further configured to execute the specific computer-executable instructions to receive or generate a second biometric image.

Clause 14. The biometric system of clause 13, further comprising extracting a second feature embedding from the second biometric image and determining the identity of the subject using the second feature embedding.

Clause 15. The biometric system of clause 14, wherein the second biometric image comprises an RGB image or a Grayscale image.

Clause 16. The biometric system of clause 1, wherein the electronic processor is configured to execute the specific computer-executable instructions to determine the identity of the subject by: generating the first reference feature embedding using a reference raw image or a reference shape-capturing image; determining a cosine distance of the first reference feature embedding with respect to the first feature embedding; and determining a cosine distance of the first reference feature embedding with respect to the first feature embedding.

Clause 17. The biometric system of clause 1, wherein the electronic processor is configured to execute the specific computer-executable instructions to extract the first feature embedding by training the recognition model by performing a multi-scale feature concatenation to hierarchically fuse high resolution and low-resolution features.

Clause 18. The biometric system of clause 1, wherein the recognition model comprises a multilayer high-resolution network (HR-NET).

Clause 19. The biometric system of clause 1, wherein the electronic processor is configured to execute the specific computer-executable instructions to extract the first feature embedding by generating a primary feature embedding using the recognition model and optimizing the primary feature embedding to generate the first feature embedding.

Clause 20. The biometric system of clause 19, wherein the electronic processor is further configured to execute the specific computer-executable instructions to optimize the primary feature embedding by performing multi-objective optimization using a loss function.

Clause 21. The biometric system of clause 20, wherein the loss function comprises one or more of an absolute loss, a contrastive loss, and an angular loss.

Clause 22. The biometric system of clause 20, wherein the loss function comprises at least an angular loss.

Clause 23. The biometric system of clause 1, wherein the feature comprises a skeleton-like pattern associated with the subject.

Clause 24. The biometric system of clause 1, wherein the first reference feature embedding comprises a second reference numerical representation of a reference feature extracted from a reference raw image.

Clause 25. The biometric system of clause 24, wherein the first numerical representation and the second reference numerical representation comprise first and second vectors and determining the identity of the subject comprise determining a cosine distance between the first and second vectors.

Clause 26. The biometric system of clause 1, wherein the electronic processor is further configured to execute the specific computer-executable instructions to determine the identity of the subject by: generating the first reference feature embedding using a reference raw image or a reference shape-capturing image; and determining a cosine distance of the first reference feature embedding with respect to the first feature embedding.

Clause 27. The biometric system of clause 26, wherein the electronic processor is further configured to execute the specific computer-executable instructions to generate the first reference feature embedding by generating a plurality of individual reference feature embeddings using a plurality of reference raw images and aggregating the plurality of reference feature embeddings to obtain an aggerate reference feature embedding, and wherein the first reference feature embedding comprises the aggerate reference feature embedding.

### Group III

Clause 1. A computer-implemented method of determining identity of a subject using a raw image comprising the subject, the computer-implemented method comprising: by an electronic processor, which is configured to execute specific computer-executable instructions stored in a non-transitory memory: receiving a shape-based biometric image of the subject comprising a biometric pattern associated with the subject; generating an enhanced parsed image of the subject using the raw image, the enhanced parsed image comprising at least one suppressed region corresponding a covered body portion of the subject; replacing the suppressed region with the corresponding region of the shape-based biometric image to generate a composite parsed image; and extracting a first feature embedding from the composite parsed image using a recognition model; and determining the identity of the subject using a first reference feature embedding and at least the first feature embedding.

Clause 2. The computer-implemented method of clause 1, wherein receiving the shape-based biometric image comprises: generating, using the raw image, a shape-capturing image; generating a distance transformed image of the shape-capturing image; and generating the shape-based biometric image by generating a multi-scale representation of the distance transformed image.

Clause 3. The computer-implemented method of clause 2, wherein the biometric pattern comprises a skeleton-like pattern associated with a skeleton of the subject.

Clause 4. The computer-implemented method of clause 2, wherein the shape-capturing image comprises an inverse silhouette image or a silhouette image.

Clause 5. The computer-implemented method of clause 1, where in the raw image comprises an RGB image or a gray-scale image.

Clause 6. The computer-implemented method of clause 2, wherein generating the distance transformed image comprises: extracting an inverse silhouette image from the raw image; and determining the distance transformed image using the inverse silhouette image.

Clause 7. The computer-implemented method of clause 2, wherein the shape-based biometric image comprises a difference of Gaussian (DoG) image and generating the multi-scale representation of the distance transformed image comprises blurring the distance transformed image using a Gaussian kernel.

Clause 8. The computer-implemented method of clause 2, wherein generating the multi-scale representation of the distance transformed image comprises generating a difference of Gaussian (DoG) pyramid and selecting a first DoG image from the DoG pyramid.

Clause 9. The computer-implemented method of clause 8, wherein generating the multi-scale representation of the distance transformed image further comprises selecting a second DoG image from the DoG pyramid age.

Clause 10. The computer-implemented method of clause 1, wherein extracting the first feature embedding from the composite parsed image comprises extracting the first feature embedding using a recognition model, the first feature embedding comprising a first numerical representation of a feature in the composite parsed image.

Clause 11. The computer-implemented method of clause 10, wherein extracting the first feature embedding comprises training the recognition model by performing a multi-scale feature concatenation to hierarchically fuse high resolution and low-resolution features.

Clause 12. The computer-implemented method of clause 10, wherein recognition model comprises a multilayer high-resolution network (HR-NET).

Clause 13. The computer-implemented method of clause 10, wherein extracting the first feature embedding comprises generating a primary feature embedding using the recognition model and optimizing the primary feature embedding to generate the first feature embedding.

Clause 14. The computer-implemented method of clause 13, wherein optimizing the primary feature embedding comprises performing multi-objective optimization using a loss function.

Clause 15. The computer-implemented method of clause 14, wherein the loss function comprises one or more of an absolute loss, a contrastive loss, and an angular loss.

Clause 16. The computer-implemented method of clause 15, wherein the first reference feature embedding comprises a first reference numerical representation of a reference feature extracted from a reference raw image.

Clause 17. The computer-implemented method of clause 16, wherein the first numerical representation and the first reference numerical representation comprise first and second vectors and determining the identity of the subject comprise determining a first cosine distance between the first and second vectors.

Clause 18. The computer-implemented method of clause 17, further comprising generating the first reference feature embedding comprises generating a plurality of individual reference feature embeddings using a plurality of reference raw images and aggregating the plurality of reference feature embeddings, to generate an aggerate reference feature embedding and wherein the first reference feature embedding comprises the aggerate reference feature embedding.

Clause 19. The computer-implemented method of clause 17, further comprising extracting a second feature embedding from the shape-based biometric image and determining a second cosine distance of a second reference feature embedding with respect to the second feature embedding.

Clause 20. The computer-implemented method of clause 19, further comprising extracting a third feature embedding from the raw image and determining a third cosine distance of a third reference feature embedding with respect to the third feature embedding.

Clause 21. The computer-implemented method of clause 1, wherein generating the enhanced parsed image of the subject comprises: generating a localized image of the subject using the raw image; generating a parsed image of the subject by parsing the localized image of the subject into an exposed body region and a covered body region; and generation the enhanced parsed image by enhancing the exposed body region and suppressing the covered body region to provide the suppressed region.

Clause 22. The computer-implemented method of clause 2, wherein enhancing the exposed body region and suppressing the covered body region comprises providing a brightness difference between a first pixel in the exposed body region and a second pixel in the covered body region.

Clause 23. The computer-implemented method of clause 22, wherein enhancing the exposed body region and suppressing the covered body region comprises one or both increasing the brightness of the first pixel and reducing the brightness of the second pixel.

Clause 24. The computer-implemented method of clause 23, wherein generating the localized image of the subject comprises extracting the localized image of the subject based on a shape-capturing image used to generate the shape-based biometric image.

### Group IV

Clause 1. A biometric system for determining identity of a subject using a shape-capturing image, the biometric system comprising: a data interface configured to receive the shape-capturing image; a non-transitory memory configured to store specific computer-executable instructions; and an electronic processor in communication with the non-transitory memory and configured to execute the specific computer-executable instructions to at least: receive a shape-based biometric image of the subject comprising a biometric pattern associated with the subject; generate an enhanced parsed image of the subject using the raw image, the enhanced parsed image comprising at least one suppressed region corresponding a covered body portion of the subject; replace the suppressed region with the corresponding region of the shape-based biometric image to generate a composite parsed image; and extract a first feature embedding of the composite parsed image using a recognition model; and determine the identity of the subject using at least a first reference feature embedding and the feature embedding.

Clause 2. The biometric system of clause 1, wherein the electronic processor is configured to execute the specific computer-executable instructions to receive the shape-based biometric image by: generating, using the raw image, a shape-capturing image; generating a distance transformed image of the shape-capturing image; and generating the shape-based biometric image by generating a multi-scale representation of the distance transformed image.

Clause 3. The biometric system of clause 2, wherein the biometric pattern comprises a skeleton-like pattern associated with a skeleton of the subject.

Clause 4. The biometric system of clause 2, wherein the shape-capturing image comprises an inverse silhouette image or a silhouette image.

Clause 5. The biometric system of clause 1, where in the raw image comprises an RGB image or a gray-scale image.

Clause 6. The biometric system of clause 2, wherein the electronic processor is configured to execute the specific computer-executable instructions to generate the distance transformed image by: extracting an inverse silhouette image from the raw image; and determining the distance transformed image using the inverse silhouette image.

Clause 7. The biometric system of clause 2, wherein the shape-based biometric image comprises a difference of Gaussian (DoG) image and generating the multi-scale representation of the distance transformed image comprises blurring the distance transformed image using a Gaussian kernel.

Clause 8. The biometric system of clause 2, wherein the electronic processor is further configured to execute the specific computer-executable instructions to generate the multi-scale representation of the distance transformed image comprises generating a difference of Gaussian (DoG) pyramid and selecting a first DoG image from the DoG pyramid.

Clause 9. The biometric system of clause 8, wherein the electronic processor is further configured to execute the specific computer-executable instructions to generate the multi-scale representation of the distance transformed image by selecting a second DoG image from the DoG pyramid age.

Clause 10. The biometric system of clause 1, wherein the electronic processor is configured to execute the specific computer-executable instructions to extract the first feature embedding from the composite parsed image by extracting the first feature embedding using a recognition model, the first feature embedding comprising a first numerical representation of a feature in the composite parsed image.

Clause 11. The biometric system of clause 10, wherein the electronic processor is configured to execute the specific computer-executable instructions to extract the first feature embedding by training the recognition model and by performing a multi-scale feature concatenation to hierarchically fuse high resolution and low-resolution features.

Clause 12. The biometric system of clause 10, wherein recognition model comprises a multilayer high-resolution network (HR-NET).

Clause 13. The biometric system of clause 10, wherein the electronic processor is configured to execute the specific computer-executable instructions to extract the first feature embedding by generating a primary feature embedding using the recognition model and optimizing the primary feature embedding to generate the first feature embedding.

Clause 14. The biometric system of clause 13, wherein the electronic processor is configured to execute the specific computer-executable instructions to optimize the primary feature embedding by performing multi-objective optimization using a loss function.

Clause 15. The biometric system of clause 14, wherein the loss function comprises one or more of an absolute loss, a contrastive loss, and an angular loss.

Clause 16. The biometric system of clause 15, wherein the first reference feature embedding comprises a first reference numerical representation of a first reference feature extracted from a reference raw image. The biometric system of claim 16, wherein the first numerical representation and the first reference numerical representation comprise first and second vectors and the electronic processor is configured to execute the specific computer-executable instructions to determine the identity of the subject comprise by determining a first cosine distance between the first and second vectors.

Clause 17. The biometric system of clause 1, wherein the electronic processor is configured to execute the specific computer-executable instructions to generate the first reference feature embedding by generating a plurality of individual reference feature embeddings using a plurality of reference raw images and aggregating the plurality of reference feature embeddings, to generate an aggerate reference feature embedding and wherein the first reference feature embedding comprises the aggerate reference feature embedding.

Clause 18. The biometric system of clause 16, wherein the electronic processor is further configured to execute the specific computer-executable instructions to extract a second feature embedding from the shape-based biometric image and determining a second cosine distance of a second reference feature embedding with respect to the second feature embedding.

Clause 19. The biometric system of clause 18, wherein the electronic processor is further configured to execute the specific computer-executable instructions to extract a third feature embedding from the raw image and determining a third cosine distance of a third reference feature embedding with respect to the third feature embedding.

Clause 20. The biometric system of clause 1, wherein the electronic processor is configured to execute the specific computer-executable instructions to generate the enhanced parsed image of the subject by: generating a localized image of the subject using the raw image; generating a parsed image of the subject by parsing the localized image of the subject into an exposed body region and a covered body region; and generation the enhanced parsed image by enhancing the exposed body region and suppressing the covered body region to provide the suppressed region.

Clause 21. The biometric system of clause 20, wherein enhancing the exposed body region and suppressing the covered body region comprises providing a brightness difference between a first pixel in the exposed body region and a second pixel in the covered body region.

Clause 22. The biometric system of clause 21, wherein the electronic processor is configured to execute the specific computer-executable instructions to enhance the exposed body region and suppressing the covered body region comprises one or both increasing the brightness of the first pixel and reducing the brightness of the second pixel.

Clause 23. The biometric system of clause 22, wherein the electronic processor is configured to execute the specific computer-executable instructions to generate the localized image of the subject by extracting the localized image of the subject based on a shape-capturing image used to generate the shape-based biometric image.

### Group V

Clause 1. A computer-implemented method of determining identity of a subject using a feature embedding extracted from a raw image comprising a subject, the method comprising: by an electronic processor, which is configured to execute specific computer-executable instructions stored in a non-transitory memory: generating, using the raw image, a shape-capturing image comprising a shape of the subject; generating a distance transformed image using the shape-capturing image; generating multi-scale representation of the distance transformed image, the multi-scale representation comprising a first shape-based biometric image of the subject; extracting a first feature embedding using at least the multi-scale representation; and determining the identity of the subject using at least a first reference feature embedding and the first feature embedding.

Clause 2. A computer-implemented method of clause 1, wherein extracting the first feature embedding comprises extracting the first feature embedding from the multi-scale representation using a recognition model, the first feature embedding comprising a numerical representation of a feature in the multi-scale representation.

Clause 3. The computer-implemented method of clause 1, wherein the shape-capturing image comprises an inverse silhouette image or a silhouette image.

Clause 4. The computer-implemented method of clause 1, further comprising generating the shape-capturing image using a raw image of the subject.

Clause 5. The computer-implemented method of clause 4, wherein the raw image comprises an RGB image or a grayscale image.

Clause 6. The computer-implemented method of clause 5, wherein generating the distance transformed image comprises: extracting an inverse silhouette image from the raw image; and determining the distance transformed image using the inverse silhouette image.

Clause 7. The computer-implemented method of clause 1, wherein the first shape-based biometric image comprises a first biometric feature of the subject.

Clause 8. The computer-implemented method of clause 7, wherein the biometric feature comprises a skeleton-like pattern associated with the subject.

Clause 9. The computer-implemented method of clause 7, wherein the biometric feature is not distinguishable in the shape-capturing image.

Clause 10. The computer-implemented method of clause 6, wherein the first shape-based biometric image comprises a difference of Gaussian (DoG) image and generating the multi-scale representation of the distance transformed image comprises blurring the distance transformed image using a Gaussian kernel.

Clause 11. The computer-implemented method of clause 1, wherein generating the multi-scale representation of the distance transformed image comprises generating a difference of Gaussian (DoG) pyramid and selecting a first DoG image from the DoG pyramid.

Clause 12. The computer-implemented method of clause 11, wherein generating the multi-scale representation of the distance transformed image further comprises selecting a second DoG image from the DoG pyramid.

Clause 13. The computer-implemented method of clause 12, wherein the multi-scale representation comprises a second shape-based biometric image.

Clause 14. The computer-implemented method of clause 13, wherein first and second shape-based biometric images comprise difference of Gaussian images derived from the distance transformed image.

Clause 15. The computer-implemented method of clause 13, wherein extracting the first feature embedding using at least the multi-scale representation, comprises extracting the first feature embedding from the biometric image and extracting a second feature embedding from the second shape-based biometric image.

Clause 16. The computer-implemented method of clause 15, wherein determining the identity of the subject comprises: generating the first reference feature embedding using a reference raw image or a reference shape-capturing image; determining a cosine distance of the first reference feature embedding with respect to the feature embedding; and determining a cosine distance of the first reference feature embedding with respect to the second feature embedding.

Clause 17. The computer-implemented method of clause 2, wherein extracting the feature embedding comprises training the recognition model by performing a multi-scale feature concatenation to hierarchically fuse high-resolution and low-resolution features.

Clause 18. The computer-implemented method of clause 2, wherein the recognition model comprises a multilayer high-resolution network (HR-NET).

Clause 19. The computer-implemented method of clause 2, wherein extracting the feature embedding comprises generating a primary feature embedding using the recognition model and optimizing the primary feature embedding to generate the feature embedding.

Clause 20. The computer-implemented method of clause 19, wherein optimizing the primary feature embedding comprises performing multi-objective optimization using a loss function.

Clause 21. The computer-implemented method of clause 20, wherein the loss function comprises one or more of an absolute loss, a contrastive loss, and an angular loss.

Clause 22. The computer-implemented method of clause 21, wherein the loss function comprises at least an angular loss.

Clause 23. The computer-implemented method of clause 2, wherein the reference feature embedding comprises a second numerical representation of a reference feature extracted from a reference raw image.

Clause 24. The computer-implemented method of clause 23, wherein the numerical representation and the second numerical representation comprise first and second vectors and determining the identity of the subject comprise determining a cosine distance between the first and second vectors.

Clause 25. The computer-implemented method of clause 24, wherein generating the reference feature embedding comprises aggregating a plurality of reference raw images to obtain an aggerate reference image and generating the reference feature embedding using the aggerate reference image.

Clause 26. The computer-implemented method of clause 1, further comprising: generating, using the raw image, an enhanced parsed image of the subject, the enhanced parsed image comprising at least one suppressed region corresponding to a covered body portion of the subject; and replace the suppressed region with the corresponding region of the first shape-based biometric image to generate a composite parsed image; extracting a second feature embedding from the composite parsed image.

Clause 27. The computer-implemented method of clause 26, wherein extracting the second feature embedding from the composite parsed image comprises extracting the second feature embedding using a recognition model, the feature embedding comprising a numerical representation of a feature in the composite parsed image.

Clause 28. The computer-implemented method of clause 27, wherein extracting the second feature embedding comprises training the recognition model.

Clause 29. The computer-implemented method of clause 28, wherein recognition model comprises a Swin transformer.

Clause 30. The computer-implemented method of clause 27, wherein extracting the second feature embedding comprises generating a primary feature embedding using the recognition model and optimizing the primary feature embedding to generate the second feature embedding.

Clause 31. The computer-implemented method of clause 30, wherein optimizing the primary second feature embedding comprises performing multi-objective optimization using a loss function.

Clause 32. The computer-implemented method of clause 31, wherein the loss function comprises one or more of an absolute loss, a contrastive loss, and an angular loss.

Clause 33. The computer-implemented method of clause 26, wherein determining the identity of the subject further comprises generating a second reference feature embedding using a reference raw image; and determining the identity of the subject using the second reference feature embedding and the second feature embedding.

Clause 34. The computer-implemented method of clause 33, wherein generating the second reference feature embedding comprises aggregating a plurality of reference feature embeddings using averaging to obtain the second reference feature embedding.

Clause 35. The computer-implemented method of clause 33, further comprising extracting a second feature embedding from the first shape-based biometric image and determining a second cosine distance of the second reference feature embedding with respect to the second feature embedding.

Clause 36. The computer-implemented method of clause 35, further comprising extracting a third feature embedding from the raw image and determining a third cosine distance of a third reference feature embedding with respect to the third reference feature embedding.

Clause 37. The computer-implemented method of clause 36, further comprising using the first, second, and third cosine distances to generate aggregated score and determining the identity of the subject using the aggregated score.

Clause 38. The computer-implemented method of clause 37, wherein the aggregated score comprises a mean value of the first, second, and third cosine distances.

Clause 39. The computer-implemented method of clause 26, wherein generating the enhanced parsed image of the subject comprises: generating a localized image of the subject using the raw image; generating a parsed image of the subject by parsing the localized image of the subject into an exposed body region and a covered body region; and generation the enhanced parsed image by enhancing the exposed body region and suppressing the covered body region to provide the suppressed region.

Clause 40. The computer-implemented method of clause 39, wherein enhancing the exposed body region and suppressing the covered body region comprises providing a brightness difference between a first pixel in the exposed body region and a second pixel in the covered body region.

Clause 41. The computer-implemented method of clause 40, wherein enhancing the exposed body region and suppressing the covered body region comprises one or both increasing the brightness of the first pixel and reducing the brightness of the second pixel.

Clause 42. The computer-implemented method of clause 39, wherein generating the localized image of the subject comprises extracting the localized image of the subject based on a shape-capturing image used to generate the first shape-based biometric image.

### Group VI

Clause 1. A computer-implemented method of extracting a feature embedding from an image, the computer-implemented method comprising: by an electronic processor, which is configured to execute specific computer-executable instructions stored in a non-transitory memory: receiving the image; generating a primary feature embedding using a recognition model; and optimizing the primary feature embedding to generate the feature embedding.

Clause 2. The computer-implemented method of clause 1, wherein extracting the feature embedding comprises training the recognition model by performing a multi-scale feature concatenation to hierarchically fuse high resolution and low-resolution features.

Clause 3. The computer-implemented method of clause 2, wherein recognition model comprises a multilayer high-resolution network (HR-NET).

Clause 4. The computer-implemented method of clause 1, wherein extracting the feature embedding comprises generating a primary feature embedding using the recognition model and optimizing the primary feature embedding to generate the feature embedding.

Clause 5. The computer-implemented method of clause 4, wherein optimizing the primary feature embedding comprises performing multi-objective optimization using a loss function.

Clause 6. The computer-implemented method of clause 6, wherein the loss function comprises one or more of an absolute loss, a contrastive loss, and an angular loss.

Clause 7. The computer-implemented method of clause 6, wherein the loss function comprises at least an angular loss.

Clause 8. The computer-implemented method of clause 1, wherein the image comprises a shape-based biometric image derived from a raw image, the shape-based biometric image comprising a biometric pattern associated with subject in the raw image.

Clause 9. The computer-implemented method of clause 8, wherein the feature embedding comprises a biometric feature of the subject.

### Group VII

Clause 1. A computer-implemented method of determining identity of a subject using at least two images comprising the subject, the computer-implemented method comprising: by an electronic processor, which is configured to execute specific computer-executable instructions stored in a non-transitory memory: receiving a first image comprising the subject; receiving a second image comprising a multi-scale representation of a distance transformed image derived from a raw image comprising the subject; generating a first matching score by extracting a first feature embedding from the first image and determining a distance between the first feature embedding and a reference feature embedding; generating a second matching score by extracting a second feature embedding from the second image and determining a distance between the second feature embedding and the second reference feature embedding; aggregating the first and second scores to generate an aggregated score; and determining the identity of the subject using the aggregated score.

### Terminology

Although systems and methods of image-based or video-based human recognition are disclosed with reference to preferred embodiments, other embodiments will be apparent to those of ordinary skill in the art from the disclosure herein. Moreover, the described embodiments have been presented by way of example only, and are not intended to limit the scope of the inventions. Rather, a skilled artisan will recognize from the disclosure herein a wide number of alternatives for the exact ordering of the image processing steps. Other arrangements, configurations, and combinations of the embodiments disclosed herein will be apparent to a skilled artisan in view of the disclosure herein and are within the spirit and scope of the inventions as defined by the claims and their equivalents.

Any combination of features described in these appendices can be implemented in combination with aspects described above. Moreover, any combination of features described in two or more of the appendices can be implemented together. As a non-limiting example, any of the features recited in the summary of certain aspects included in one of the appendices can be combined with any of the features recited in the summary of certain aspects included in one or more of the other appendices, as appropriate.

Reference to any prior art in this specification is not, and should not be taken as, an acknowledgement or any form of suggestion that the prior art forms part of the common general knowledge in the field of endeavour in any country in the world.

Where reference is used herein to directional terms such as ‘up’, ‘down’, ‘forward’, ‘rearward’, ‘horizontal’, ‘vertical’ etc., those terms refer to when the apparatus is in a typical in-use position and are used to show and/or describe relative directions or orientations.

Unless the context clearly requires otherwise, throughout the description and the claims, the words “comprise”, “comprising”, and the like, are to be construed in an inclusive sense as opposed to an exclusive or exhaustive sense, that is to say, in the sense of “including, but not limited to”.

The terms “approximately,” “about,” and “substantially” as used herein represent an amount close to the stated amount that still performs a desired function or achieves a desired result. For example, in some embodiments, as the context may permit, the terms “approximately”, “about”, and “substantially” may refer to an amount that is within less than or equal to 10% of, within less than or equal to 5% of, and within less than or equal to 1% of the stated amount.

The disclosed apparatus and systems may also be said broadly to consist in the parts, elements and features referred to or indicated in the specification of the application, individually or collectively, in any or all combinations of two or more of said parts, elements or features.

Depending on the embodiment, certain acts, events, or functions of any of the algorithms, methods, or processes described herein can be performed in a different sequence, can be added, merged, or left out altogether (for example, not all described acts or events are necessary for the practice of the algorithms). Moreover, in certain embodiments, acts or events can be performed concurrently, for example, through multi-threaded processing, interrupt processing, or multiple processors or processor cores or on other parallel architectures, rather than sequentially.

It should be noted that various changes and modifications to the presently preferred embodiments described herein will be apparent to those skilled in the art. Such changes and modifications may be made without departing from the spirit and scope of the disclosed apparatus and systems and without diminishing its attendant advantages. For instance, various components may be repositioned as desired. It is therefore intended that such changes and modifications be included within the scope of the disclosed apparatus and systems. Moreover, not all of the features, aspects and advantages are necessarily required to practice the disclosed apparatus and systems.

Conditional language used herein, such as, among others, “can,” “could,” “might,” “may,” “e.g.,” “for example,” “such as” and the like, unless specifically stated otherwise, or otherwise understood within the context as used, is generally intended to convey that certain embodiments include, while other embodiments do not include, certain features, elements and/or states. Unless the context clearly requires otherwise, throughout the disclosure, the words “comprise,” “comprising,” “include,” “including,” and the like are to be construed in an inclusive sense, as opposed to an exclusive or exhaustive sense; that is to say, in the sense of “including, but not limited to.” The words “coupled” or connected”, as generally used in this disclosure, refer to two or more elements that may be either directly connected, or connected by way of one or more intermediate elements. Additionally, the words “herein,” “above,” “below,” and words of similar import, when used in this application, shall refer to this application as a whole and not to any particular portions of this application.

Where the context permits, words in this disclosure using the singular or plural number may also include the plural or singular number, respectively. The words “or” in reference to a list of two or more items, is intended to cover all of the following interpretations of the word: any of the items in the list, all of the items in the list, and any combination of the items in the list. All numerical values provided herein are intended to include similar values within a measurement error.

What is claimed is:

1. A computer-implemented method of determining identity of a subject using a shape-capturing image comprising the subject, the computer-implemented method comprising:
by an electronic processor, which is configured to execute specific computer-executable instructions stored in a non-transitory memory:
receiving the shape-capturing image;
generating a distance transformed image using the shape-capturing image;
generating a multi-scale representation of the distance transformed image,
extracting a first feature embedding from the multi-scale representation using a recognition model, the first feature embedding comprising a first numerical representation of a feature in the multi-scale representation; and
determining the identity of the subject using at least the first feature embedding and a first reference feature embedding.

2. The computer-implemented method of claim 1, wherein the shape-capturing image comprises an inverse silhouette image or a silhouette image.

3. The computer-implemented method of claim 1, further comprising generating the shape-capturing image using a raw image of the subject.

4. The computer-implemented method of claim 3, wherein the raw image comprises an RGB image or a grayscale image.

5. The computer-implemented method of claim 3, wherein generating the distance transformed image comprises:
extracting an inverse silhouette image from the raw image; and
determining the distance transformed image using the inverse silhouette image.

6. The computer-implemented method of claim 1, wherein the multi-scale representation comprises a first biometric image comprising a biometric feature of the subject.

7. The computer-implemented method of claim 6, wherein the first biometric image comprises a skeleton-like pattern associated with the subject.

8. The computer-implemented method of claim 6, wherein the biometric feature is not distinguishable in the shape-capturing image.

9. The computer-implemented method of claim 1, wherein generating the multi-scale representation of the distance transformed image comprises generating a Difference of Gaussian (DoG) pyramid and selecting a first DoG image from the DoG pyramid.

10. The computer-implemented method of claim 9, wherein generating the multi-scale representation of the distance transformed image further comprises selecting a second DoG image from the DoG pyramid.

11. The computer-implemented method of claim 10, further comprising extracting the first feature embedding from the first DoG image and extracting a second feature embedding from the second DoG image and determining the identity of the subject further using the second feature embedding.

12. The computer-implemented method of claim 6, further comprising, receiving or generating a second biometric image, extracting a second feature embedding from the second biometric image, and determining the identity of the subject using the second feature embedding.

13. The computer-implemented method of claim 1, wherein determining the identity of the subject comprises:
generating the first reference feature embedding using a reference raw image or a reference shape-capturing image;
determining a cosine distance of the first reference feature embedding with respect to the first feature embedding; and
determining a cosine distance of the first reference feature embedding with respect to the first feature embedding.

14. The computer-implemented method of claim 1, wherein extracting the first feature embedding comprises training the recognition model by performing a multi-scale feature concatenation to hierarchically fuse high resolution and low-resolution features.

15. The computer-implemented method of claim 1, wherein extracting the first feature embedding comprises generating a primary feature embedding using the recognition model and optimizing the primary feature embedding to generate the first feature embedding.

16. The computer-implemented method of claim 1, wherein the feature comprises a skeleton-like pattern associated with the subject.

17. The computer-implemented method of claim 1, wherein the first reference feature embedding comprises a second numerical representation of a reference feature extracted from a reference raw image.

18. The computer-implemented method of claim 17, wherein the first numerical representation and the second numerical representation comprise first and second vectors and determining the identity of the subject comprise determining a cosine distance between the first and second vectors.

19. The computer-implemented method of claim 1, wherein determining the identity of the subject comprises:
generating the first reference feature embedding using a reference raw image or a reference shape-capturing image; and
determining a cosine distance of the first reference feature embedding with respect to the first feature embedding.

20. The computer-implemented method of claim 19, wherein generating the first reference feature embedding comprises generating a plurality of reference feature embeddings using a plurality of reference raw images and aggregating the plurality of reference feature embeddings to obtain an aggerate reference feature embedding, and wherein the first reference feature embedding comprises the aggerate reference feature embedding.
